(19) United States
(12) Patent Application Publication
(10) Pub. No.: US 2003/0165184 A1
(43) Pub. Date: Sep. 4, 2003

(54) M-ary orthogonal coded communications method and system

(76) Inventors: Matthew L. Welborn, Vienna, VA (US); John W. McCorkle, Vienna, VA (US)

Correspondence Address: XtremeSpectrum, Inc., 8133 Leesburg Pike, Suite 700, Vienna, VA, 22182, US

(21) Appl. No.: 10/367,834

(22) Filed: Feb. 19, 2003

Related U.S. Application Data
(60) Provisional application No. 60/357,638, filed on Feb. 20, 2002.

(51) Int. Cl. H04B 1/707; H04K 1/00

(52) U.S. Cl. 375/146; 375/309

(57) ABSTRACT

A transmitter encodes and a receiver decodes a signal using M-ary bi-orthogonal keying. The transmitter receives a stream of data bits and breaks a number of data bits off of the stream to form a bit sequence. The transmitter then chooses a code that corresponds the bit sequence, and transmits the chosen code. The receiver receives the code and correlates it with all possible codes to generate a plurality of correlation values. It then compares these correlation values to determine which code was sent, and therefore what the received bit sequence is. The codes are all mutually orthogonal, and preferable include a plurality of code words and an equal number of code word inverses. The code may be scrambled by multiplying it with a pseudo-random sequence at the transmitter, and descrambled by multiplying it by the same pseudo-random sequence at the receiver.

### CROSS-REFERENCE TO RELATED PATENT DOCUMENTS

This application relies for priority on U.S. provisional application serial No. 60/357,638, by Matthew L. Welborn, filed Feb. 20, 2002, entitled “AN M-ARY BI-ORTHOGONAL CODED ULTRAWIDEBAND COMMUNICATIONS SYSTEM,” the contents of which is hereby incorporated by reference in its entirety.

### BACKGROUND OF THE INVENTION

The present invention relates to ultrawide bandwidth (UWB) transmitters, receivers and transmission schemes. More particularly, the present invention relates to a method and system for sending data across a UWB signal using M-ary bi-orthogonal keying.

The following is a general description of a UWB system, noting particularly how it is applicable to wireless networks. Although UWB technology has also been used in radar and ranging applications, the following discussion addresses only issues relevant to wireless networking applications.

It is helpful to briefly note some important design issues for indoor wireless networks. Such systems will need to operate over relatively short ranges in environments with multipath interference, but will need to provide high data rates, preferably using spectrum licensed by the Federal Communications Commission (FCC). Also, such systems are often used to support mobility, so they need low power dissipation to enable battery operation and, as always, low cost and complexity is an advantage.

Characteristics of UWB Systems

One embodiment of a UWB system uses signals that are based on trains of short duration pulses (also called chips) formed using a single basic pulse shape. The interval between individual pulses can be uniform or variable, and there are a number of different methods that can be used for modulating the pulse train with data for communications. One common characteristic, however, is that the pulse train is transmitted without translation to a higher carrier frequency, and so UWB is sometimes also termed “carrier-less” radio. In other words, in this embodiment a UWB system drives its antenna directly with a baseband signal.

Another important point common to UWB systems is that the individual pulses are very short in duration, typically much shorter than the interval corresponding to a single bit, which can offer advantages in resolving multipath components. We can represent a general UWB pulse train signal as a sum of pulses shifted in time, as shown in Equation 1:

$$s ( t ) = {\sum }_{k = - ∞}^{∞} {a}_{k} p ( t - {t}_{k} ) \qquad ( 1 )$$

Here s(t) is the UWB signal, p(t) is the basic pulse shape, and aₖ and tₖ are the amplitude and time offset for each individual pulse. Because of the short duration of the pulses, the spectrum of the UWB signal can be several gigahertz or more in bandwidth. An example of a typical pulse stream is shown in FIG. 1. Here the pulse is a Gaussian mono-pulse with a peak-to-peak time (Tₚ₋ₚ) of a fraction of a nanosecond, a pulse period Tₚ of several nanoseconds, and a bandwidth of several gigahertz.

UWB Systems Limited to Low Power Spectral Density

UWB systems in general have extremely wide absolute bandwidth relative to most existing wireless systems. This bandwidth is a direct consequence of the use of sub-nanosecond pulses that leads to signal bandwidths of several gigahertz or more. Because these signals are also transmitted without translation to higher center frequencies, it is clear that these signals will occupy the same frequency bands that are already in use by many existing spectrum users.

Because of rulings by the FCC, future UWB systems will likely be limited to operations using extremely low power spectral density (as measured in dBm/MHz). Based on this fact, it is clear that even with a bandwidth of several gigahertz, UWB systems will also be limited to relatively low total transmit power. For example, a UWB system with 5 GHz of bandwidth might have a maximum total transmit power of only a small fraction of a milliwatt over the entire 5 GHz of bandwidth.

Operation in the Power-Limited Regime

The bandwidth efficiency of a digital modulation scheme that transmits B bits in T seconds (R bits/sec) using a bandwidth of W hertz is given by R/W=B/(WT) bits/s/Hz. As we will see, the bandwidth efficiency of a UWB system is not important in the sense of how efficiently it uses spectrum, but rather the value of this ratio serves to distinguish UWB systems from more typical narrowband systems. Based on this ratio, R/W, digital communications systems can be classified as operating in either the bandwidth-limited regime or the power-limited regime of the bandwidth-efficiency plane. This classification has fundamental implications for many of the important trade-offs that must be made in the design of efficient communications systems.

For future UWB systems, the R/W ratio will likely be very low for the system to have any useful range. For example, even for a relative high-rate wireless network (say 100 Mbps), the bandwidth efficiency of a UWB wireless network will be as low as

$$\frac{1}{20}$$

or even

$$\frac{1}{50} ,$$

depending on the bandwidth W. The primary consequence of this low value for the ratio R/W is that UWB systems will almost certainly operate well within the power-limited regime of the bandwidth-efficiency plane.

The Critical Importance of Power Efficiency

The main result of UWB operation in the power-limited regime is that such systems will be very sensitive to design issues that affect the power efficiency of the system. For this reason, the analysis in the following sections will focus on the critical issues of power efficiency of the UWB modulation techniques, as well as the spectral effects of modulation that might also affect allowable transmit power levels. The implications of power-limited operation will also influence system-level trade-offs between range and data rate, as well as trade-offs between complexity and performance in the form of forward error-correction.

Multipath Robustness and Precision Ranging

One frequently mentioned benefit of ultra-wide bandwidth is a robustness to the effects of multipath interference. Multipath interference results when multiple time-displaced copies of a signal reach a receiver at the same time because of signal bounces in a cluttered environment. This robustness is a result of two distinct factors: (1) wide fractional bandwidth leads to less severe multipath fading, which is particularly important for low-power wireless systems; and (2) wide absolute bandwidth enables resolution of multipath components and constructive use of multipath.

The effect of reduced multipath fading can be partially understood from a frequency-domain perspective by realizing that the absolute signal bandwidth of the UWB signal is much greater than the coherence bandwidth of nearly any conceivable multipath channel. Any frequency-selective fades due to multipath will only affect a small portion of the signal power for any channel realization. Previous work provides empirical evidence that UWB signals experience a much lower variance in received signal power in the presence of multipath than do narrowband signals.

For UWB signals, robustness to multipath fading is result not just of the wide system bandwidth, however, but is also a result of the large ratio of system bandwidth to center frequency, i.e., the fractional bandwidth. A large fractional bandwidth means that there is a corresponding large variation in the mode and degree of RF energy interaction with the surrounding environment over the entire UWB bandwidth. Environmental interactions such as scattering, refraction and reflection depend on the wavelength of the RF signals, and so the large fractional bandwidth leads to relatively low correlation in the fading properties of the different regions of the UWB bandwidth. Thus, the properties of UWB signals should lead to more robust multipath performance even than systems with equal bandwidth but much higher center frequencies (i.e. lower fractional bandwidths). A more detailed analysis of this effect is presented in a companion paper in this same issue.

The wide absolute bandwidth of UWB signals also provides fine time resolution that enables a receiver to resolve and combine individual multipath components, avoiding destructive interference.

Analysis of UWB Modulation Choices

Under current FCC regulations, UWB transmit power is limited by the power spectral density (PSD) of the transmitted signal. FIG. 2 is a graph showing the power spectral density limits currently put in force by the FCC.

This limitation affects the selection of a UWB modulation scheme in two distinct ways. First, the modulation technique needs to be power efficient. In other words, the modulation needs to provide the best error performance for a given energy per bit. Second, the choice of a modulation scheme affects the structure of the PSD in the sense that it affects the distribution of signal power over different frequency bands. If a particular modulation scheme results in the concentration of signal power in narrow frequency ranges, it has the potential to impose additional constraints on the total transmit power in order to satisfy the PSD limitations.

As we compare different modulation schemes, we therefore examine both the power efficiency and the effect of the modulation on the PSD. In the sections that follow, we examine a number of modulation schemes that have been proposed for UWB, including several forms of pulse amplitude modulation (PAM), such as: positive pulse amplitude modulation (PPAM), on-off keying (OOK), and binary phase-shift keying (BPSK), as well as pulse-position modulation (PPM).

Pulse Amplitude Modulation

As noted above, one general form of a UWB signal is a simple pulse train. Assuming that pulses are uniformly spaced in time (i.e. the k^{th} pulse occurs at time t=kT), then we can simplify Equation (1) to:

$$s ( t ) = {\sum }_{k = - ∞}^{∞} {a}_{k} p ( t - kT ) \qquad ( 2 )$$

where T is the pulse-spacing interval. From this general form of PAM, we can analyze several specific modulation techniques by choosing the mapping from data bits to pulse weights (aₖ) in different ways. These different techniques are illustrated in FIGS. 3A-3C, and are described in the following paragraphs.

FIGS. 3A and 3B are graphs showing exemplary pulse streams for OOK, PPAM, and BPSK modulation schemes, respectively. In each case, they show a data sequence “1 0 1 0.” FIGS. 4A-4C are constellation diagrams for the modulation schemes of FIGS. 3A-3C, respectively. As shown in FIGS. 4A-4C, the constellation diagrams for OOK, PPAM, and BPSK are all one-dimensional, differing only in the symbol constellation's position relative to the origin.

On-Off Keying

As shown in FIG. 3A, OOK defines the data by the presence or absence of a pulse. A “1” is indicated by a pulse, and a “0” is indicated by the absence of a pulse. Thus, the bit stream “1 0 1 0” is indicated by the sequence of: a pulse, a blank where a pulse should be, a pulse, and another blank.

This embodiment has aₖ∈{0,2}, i.e., data bits are transmitted by either the presence or absence of a pulse at time t=tₖ. In the constellation diagram in FIG. 4A, this results in symbol points at (0,0) and (2,0).

Positive Pulse Amplitude Modulation

As shown in FIG. 3B, PPAM defines the data by the amplitude of the pulse. A “1” is indicated by a large pulse, and a “0” is indicated by a small pulse. Thus, the bit stream “1 0 1 0” is indicated by the sequence of: a large pulse, a small pulse, a large pulse, and a small pulse.

This embodiment uses strictly positive values for the two pulse weights, so that aₖ∈{α₀, α₁} where 0<α₀<α₁. This corresponds to transmitting either a large or small amplitude pulse based on the value of the source bit. In the constellation diagram of FIG. 4B this is shown as having signal points at (α₀, 0) and (α₁, 0).

Binary Phase Shift Keying

As shown in FIG. 3C, BPSK defines the data by the polarity of the pulse. A “1” is indicated by a non-inverted pulse, and a “0” is indicated by an inverted pulse. Thus, the bit stream “1 0 1 0” is indicated by the sequence of: a non-inverted pulse, an inverted pulse, a non-inverted pulse, and an inverted pulse.

In this embodiment aₖ∈{−1,+1}. This corresponds to transmitting either a non-inverted or an inverted pulse based on the value of the source bit. In the constellation diagram of FIG. 4C this is shown as having signal points at (−1, 0) and (1, 0).

Pulse-Position Modulation

One other technique proposed for UWB pulse modulation, PPM, is fundamentally different from the PAM techniques described above because the pulses are not uniformly spaced in time. Rather, the source data bits are used to modulate the time position of the individual pulses instead of the pulse amplitudes. For example, binary PPM encodes the data bits in the pulse stream by advancing or delaying individual pulses in time relative to uniform reference positions. In this case, the equation for the UWB signal becomes

$$s ( t ) = {\sum }_{k = - ∞}^{∞} p ( t - {t}_{k} ) = {\sum }_{k = - ∞}^{∞} p ( t - kT + {a}_{k} β ) \qquad ( 3 )$$

Here the data bits are mapped to the direction of the time shifts, aₖ, where aₖ∈{−1,1}, and β is the amount of pulse advance or delay in time relative to the reference (unmodulated) position. When we consider the constellation diagram for binary PPM, we find that the plot is no longer one dimensional, as it is for the binary PAM techniques. For PPM, the presence of two pulse with different time offsets results in a two-dimensional constellation plot. To find the specific location of the symbol points within the plot, however, we need to determine the correlation ρ between the two different symbols, the advanced and delayed pulses.

$$ρ = \frac{{\int }_{t = - ∞}^{∞} p ( t - β T ) p ( t + β T ) ⅆ t}{{\int }_{t = - ∞}^{∞} p ( t ) p ( t ) ⅆ t} \qquad ( 4 )$$

FIGS. 5A-5C are constellation diagrams for pulse position modulation schemes under various conditions for binary PPM based on the pulse shown in FIG. 1. FIG. 5A shows as situation where the pulses are orthogonal (i.e., ρ=0); FIG. 5B shows the situation where the pulses are not orthogonal and ρ>0; and FIG. 5C shows the situation where the pulses are not orthogonal and ρ<0.

For the non-orthogonal cases of binary PPM, the orthogonal basis function used to define the constellation plot can be found using Gram-Schmidt orthogonalization for the two non-orthogonal pulses. The constellation diagrams in FIGS. 5A-5C all have symbol points at (1,0) and (ρ,√1−ρ²), and the two symbol points lie on the unit circle (when normalized to unit energy).

In the case where the two different locations of the pulse have no overlap in time, the correlation will clearly be (ρ≈0) and the binary PPM becomes orthogonal modulation. The constellation for this case is shown in FIG. 5A, where the symbol points are (1,0) and (0,1). Here the two orthogonal pulses have been used to create orthogonal basis vectors for the constellation plot.

When the two pulses overlap, the correlation ρ in general will not be zero, but will range between one and some minimum (possibly negative) value.

Comparison of Power Efficiency for Binary Modulation

We can use the constellation diagrams in FIGS. 4A-4C and 5A-5C to compare the power efficiency of the various binary modulation techniques by computing the inter-symbol distance, d, as a function of average symbol energy, Eₛ. For OOK, we have

$${E}_{s} = \frac{( {0}^{2} + {d}^{2} )}{2} ,$$

so d=\sqrt{2Eₛ}. For positive-valued PAM (PPAM) we see that d=(α₁−α₀), so Eₛ=

$${E}_{s} = \frac{( {α}_{0}^{2} + {( d + {α}_{0} )}^{2} )}{2} .$$

Solving for d, we get d=(\sqrt{2Eₛ−α₀²}−α₀). If we assume α₀≧0, then we have d≦\sqrt{2Eₛ}, which is satisfied with equality when α₀=0 (i.e. when PPAM becomes OOK). For antipodal binary PAM (BPSK) we have

$${E}_{s} = {( \frac{d}{2} )}^{2} ,$$

so d=2\sqrt{Eₛ}.

For binary PPM, the inter-symbol distance depends on the correlation between the advanced and delayed pulses defined in Equation (4) and for the general case, d=\sqrt{2Eₛ(1−ρ)}. Here we see that if the value of ρ ranges between −1 and +1, the distance can range between d=0 and d=2\sqrt{Eₛ}. The actual maximum and minimum values for ρ that determine this range of possible inter-symbol distances depend on the specific shape of the pulse p(t) and can be determined according to Equation (4) for different values of β. For the example Gaussian mono-pulse shown in FIG. 1, the value of p as defined in Equation (4) ranges from (+1) to approximately (−0.45) as β ranges from zero to several multiples of Tₚ.

TABLE 1
Differences Between Modulation Techniques

| | | | Power Efficiency |
|---|---|---|---|
| Modulation | | Inter-symbol | Relative to |
| Class | Specific Form | Distance | Antipodal Signaling |
| Pulse-position | Orthogonal | d = \sqrt{2E_{b}} | −3 dB |
| Modulation | Non-orthogonal | d = {square root over (2E_{b}1 − ρ))} | <1.4 dB (variable) |
| Amplitude | Positive PAM | d < \sqrt{2E_{b}} | <−3 dB |
| Modulation | OOK | d = \sqrt{2E_{b}} | −3 dB |
| | Antipodal | d = 2\sqrt{E_{b}} | 0 dB |

These results show significant differences between the modulation techniques and are summarized in Table 1. The orthogonal PPM and OOK techniques are equally efficient and the positive PAM system is less so, but becomes the same in the limit as the PAM becomes OOK. Non-orthogonal PPM has a power efficiency that depends on the symbol correlation ρ, but is still suboptimal. Antipodal signaling (BPSK) provides the greatest inter-symbol distance for a given average symbol energy. This difference provides at least a 3 dB advantage in efficiency relative to OOK, PPAM, or orthogonal PPM, and to achieve the same bit error rate (which is a function of distance) PPM or OOK must use double the bit energy, or 3 dB higher E_{b}.

Decomposition of Binary Modulation Techniques

For the binary PAM techniques depicted in FIGS. 4A-4C, the constellation diagrams differ only in their position relative to the origin. It is a well-known result in communications theory that power efficiency depends on the mean of the symbol constellation—this is why the zero-mean property of the BPSK makes it superior in the ratio of inter-symbol distance to symbol energy. Another way to understand this difference is to decompose the weight sequence into a constant value sequence added to a zero-mean random sequence: aₖ=μₐ+zₖ. This sequence decomposition allows us to represent the UWB pulse train as the sum of an unmodulated component pulse train and an antipodal component pulse train:

$$s ( t ) = {\sum }_{k = - ∞}^{∞} {μ}_{a} p ( t - kT ) = {\sum }_{k = - ∞}^{∞} {z}_{k} p ( t - kT ) \qquad ( 5 )$$

From this result we can easily see the source of the difference in power efficiency for the PAM techniques. The energy in the unmodulated component of the pulse train above does not contribute to communicating data between the transmitter and receiver, and is effectively wasted. Only the energy in the antipodal component contributes to the communications process. The greater the energy in the unmodulated component (i.e. the higher the mean μₐ for a give distance d) the poorer is the power efficiency of the modulation. BPSK is thus seen to be optimal for binary techniques since it has zero-mean and all of its energy is contained in the antipodal component of the pulse train.

For PPM, we can perform a similar, but more general, decomposition of the pulse train. Here we must use unmodulated and antipodal components that, unlike PAM, have different pulse shapes. We define two new pulses:

$$m ( t ) = \frac{p ( t - β T ) + p ( t + β T )}{2} , and b ( t ) = \frac{p ( t - β T ) - p ( t + β T )}{2} \qquad ( 6 )$$

These pulses represent the unmodulated [m(t)] and antipodal [b(t)] pulse train components. We can use these two pulses to write the UWB pulse train as the sum of two separate component pulse trains:

$$s ( t ) = {\sum }_{k = - ∞}^{∞} {μ}_{a} m ( t - kT ) + {\sum }_{k = - ∞}^{∞} {z}_{k} b ( t - kT ) \qquad ( 7 )$$

Using this decomposition, we see that data bits are transmitted by sending either [m(t)+b(t)] or [m(t)−b(t)] at each time interval t=kT. The sign of the component m(t) is independent of the data value and is therefore not modulated. Two examples of this decomposition for binary PPM are shown in FIGS. 6A and 6B for values of β that result in both overlapping and non-overlapping pulses.

FIGS. 6A-6D are graphs showing component pulses for the decomposition of binary PPM into unmodulated and antipodal pulse trains. FIG. 6A shows the original pulses with β=5Tₚ; FIG. 6B shows the original pulses with β=1.5Tₚ; FIG. 6C shows the unmodulated component pulse [m(t)] and antipodal component pulse [b(t)] for β=5Tₚ; and FIG. 6D shows the unmodulated component pulse [m(t)] and antipodal component pulse [b(t)] for β=1.5Tₚ.

As with the PAM cases above, we can see that the energy in the unmodulated component of the pulse train defined by m(t) is useless in the communication of information and leads to inefficient modulation.

Spectral Effects of Modulation Techniques

Another important consideration in evaluating a UWB modulation technique is the effect of the modulation on the spectrum of the transmitted signal. As noted in an earlier section, UWB signals have been limited by the FCC by the peak of their PSD, so that for best system performance signals should be designed to maximize transmit power for given limits on PSD levels.

Spectral Analysis for PAM

To understand the effect of the modulation scheme on the UWB signal, we need to find the spectrum not of the isolated pulse, but of the modulated pulse train. If we assume that the modulating data are random, the transmitted pulse train is also a random signal and as such does not have a deterministic Fourier transform. However, we can still understand the effects of modulation on the spectral distribution of signal power by finding its expectation over the random source data sequences. This power spectral density (PSD) of the transmit signal, s(t), is the Fourier transform of the signal autocorrelation and is denoted by Φₛₛ(f). Because the pulses in a PAM UWB signal are uniformly spaced as in Equation (2), we can derive a general form for the PSD of the PAM signals as follows:

Φₛₛ(f)=|P(f)|²Φₐₐ(f) (8)

Here P(f) is the Fourier transform of the basic pulse, p(t), and Φₐₐ(f) is the PSD of the random data sequence, aₖ, which is hereafter assumed to be a wide-sense stationary random sequence. If we assume that the pulse weights aₖ correspond to the data bits to be transmitted and that the random data are independent and identically distributed (IID), then the PSD can be determined as follows:

$${Φ}_{aa} ( f ) = {σ}_{a}^{2} + \frac{{μ}_{a}^{2}}{T} {\sum }_{k = - ∞}^{∞} δ ( f - \frac{k}{T} ) \qquad ( 9 )$$

where σₐ² and μₐ are the variance and mean of the weight sequence and δ(f) is a unit impulse function. This PSD is periodic in the frequency domain with period

$$f = \frac{1}{T}$$

because it is the transform of the discrete auto-correlation sequence, Φₐₐ(k)=E{aₙ+ₖaₙ*}. This PSD in Equation (9) has both a continuous portion and discrete spectral lines, corresponding to the first and second terms on the right-hand side. It is worth noting that the magnitude of the spectral lines depends on the mean of the weights, μₐ. In light of the decomposition described above, we see that the energy in the unmodulated component of the pulse train is the energy in the spectral lines and the energy in the antipodal component is the energy of the continuous spectral component.

When we combine the results of Equations (8) and (9) we see that the resulting PSD of the transmitted signal is equivalent to the result of filtering a weighted impulse sequence through a filter with frequency response P(f):

$${Φ}_{ss} ( f ) = \frac{{σ}_{a}^{2}}{T} {\vert P ( f ) \vert}^{2} + \frac{{μ}_{a}^{2}}{{T}^{2}} {\sum }_{k = - ∞}^{∞} {\vert P ( \frac{k}{T} ) \vert}^{2} δ ( f - \frac{k}{T} ) \qquad ( 10 )$$

At this point we can again consider the different modulation techniques for PAM described earlier. The PSD for the OOK signal with pulse amplitudes weights aₖ∈{0, 2} is determined as follows:

$${Φ}_{ss , OOK} ( f ) = \frac{1}{T} {\vert P ( f ) \vert}^{2} + \frac{1}{{T}^{2}} {\sum }_{k = - ∞}^{∞} {\vert P ( \frac{k}{T} ) \vert}^{2} δ ( f - \frac{k}{T} ) \qquad ( 11 )$$

In this equation we see that OOK results in discrete spectral lines in the PSD of the UWB signal. The spectral lines are spaced at a frequency interval of

$$f = \frac{1}{T}$$

and each line has power proportional to P(f) evaluated at

$$F = \frac{k}{T} .$$

For OOK the total power in the spectral lines is equal to the power in the continuous component of the PSD, as shown above. A similar result is obtained for the positive-valued PAM signal, where we have

$${σ}_{a}^{2} = \frac{{( {α}_{0} - {α}_{1} )}^{2}}{4}$$

and

$${μ}_{a} = \frac{( {α}_{0} + {α}_{1} )}{2} .$$

Substituting these values in Equation (8) the PSD becomes:

$${Φ}_{ss , PPAM} ( f ) = \frac{{( {α}_{0} - {α}_{1} )}^{2}}{4 T} {\vert P ( f ) \vert}^{2} + \frac{{( {α}_{0} + {α}_{1} )}^{2}}{4 {T}^{2}} {\sum }_{k = - ∞}^{∞} {\vert P ( \frac{k}{T} ) \vert}^{2} δ ( f - \frac{k}{T} ) \qquad ( 12 )$$

We see that, as with OOK, there are spectral lines present in the transmitted signal for positive-valued PAM and furthermore that the magnitude of the lines increases with the weight sequence mean. Note that PPAM spectrum becomes the same as the OOK spectrum when α₀→0.

The situation is very different for antipodal signaling, where aₖ∈{−1,+1}, so that σₐ²=1 and μₐ=0. In this case, the PSD becomes simply:

$${Φ}_{ss , BPSK} ( f ) = \frac{{σ}_{a}^{2}}{T} {\vert P ( f ) \vert}^{2} = \frac{1}{T} {\vert P ( f ) \vert}^{2} \qquad ( 13 )$$

Here we see that the spectral lines vanish because of the zero mean of the weight sequence. Because the PSD for BPSK has no lines, the spectral distribution of energy does not depend on the pulse interval T or the pulse-repetition frequency (PRF). Rather the presence of T in Equation (13) only shows that the total power of the transmit signal increases linearly at all frequencies with the PRF when pulse amplitude is constant.

Spectral Analysis for PPM

The results of Equations (8) and (9) do not directly apply to the case of PPM because the pulses do not have uniform spacing in time. To find the PSD for PPM signals, however, we can use the decomposition technique described in Equation (7) above that allowed us to represent the PPM signal as the sum of two uniformly spaced pulse trains. From the definitions in Equation (6) it is clear that m(t) and b(t) are orthogonal regardless of the orthogonality of the shifted pulses p(t−β) and p(tβ). Using this fact, we can find the PSD of the composite pulse train in Equation (7), the PSD of the binary PPM signal as follows:

$${Φ}_{ss , PPM} ( f ) = \frac{{σ}_{a}^{2}}{T} {\vert B ( f ) \vert}^{2} + \frac{{μ}_{a}^{2}}{{T}^{2}} {\sum }_{k = - ∞}^{∞} {\vert M ( \frac{k}{T} ) \vert}^{2} δ ( f - \frac{k}{T} ) \qquad ( 14 )$$

Where B(f) and M(f) are the Fourier transforms of the component pulses b(t) and m(t), respectively. As with the case of the PAM signals, it is clear that the energy that corresponded to the unmodulated pulse train in Equation (7) here translates to energy contained in spectral lines. Similarly, the energy in the antipodal portion of the signal translates to the energy of the continuous spectral component of Equation (14).

One significant difference between the PAM and PPM spectra is that for PPM the envelope of the magnitudes of the spectral lines can be different from the shape of the continuous spectrum.

The continuous component of the PSD has a shape that depends on B(f), but the power distribution in the spectral lines depends on M(f). These spectral lines still have a frequency spacing of

$$f = \frac{1}{T} ,$$

but the distribution of power in the lines can be significantly different.

In general, both the distribution of energy between the discrete and continuous components of the spectrum, as well as the distribution of spectral energy with respect to frequency, depend on the shape of the original pulse p(t) and the magnitude of the time shift, βT. As with the PAM signals, we can conclude that from the viewpoint of the system designer it is desirable to minimize the energy in the spectral lines. For PPM this is done by minimizing the correlation value p, with the additional consideration that the shape of the component pulses m(t) and b(t) may result in less uniform distribution of energy in the spectrum. This could in turn lead to suboptimal designs for a PSD-limited system.

### SUMMARY OF THE INVENTION

Consistent with the title of this section, only a brief description of selected features of the present invention is now presented. A more complete description of the present invention is the subject of this entire document.

An object of the present invention is to provide a method and system of encoding and decoding multiple bits of data into a single UWB transmission.

Another object of the present invention is to maximize the power output of a UWB signal without violating FCC power spectral density limitations.

Another feature of the present invention is to increase the power efficiency of receiver circuits.

These and other objects are accomplished by way of a method of encoding a signal using M-ary orthogonal keying. This method comprises: receiving a stream of data bits; breaking B data bits off of the stream of data bits to form a B-bit sequence; choosing a code that corresponds the B-bit sequence from among K unique codes; and transmitting the chosen code. The K unique codes each preferably correspond to one possible combination of the B data bits. B is preferably an integer greater than 1, and K is preferably an integer greater than 3. The K code words are all preferably either mutually orthogonal, or nearly orthogonal using a random correlation threshold. The signal may be an ultrawide bandwidth signal.

In some embodiments K=2^{(B)}, and B is between 2 and 8. In some embodiments K is even and the plurality of codes comprise K/2 code words and K/2 code word inverses.

A method is also provided of encoding a signal using M-ary orthogonal keying. This method comprises: receiving a stream of data bits; breaking B data bits off of the stream of data bits to form a B-bit sequence; choosing a code that corresponds the B-bit sequence from among K unique codes; multiplying the chosen code by a pseudo-random sequence to form a scrambled code; transmitting the scrambled code. The K unique codes each preferably correspond to one possible combination of the B data bits. B is preferably an integer greater than 1, and K is preferably an integer greater than 3. The K code words are all preferably either mutually orthogonal, or nearly orthogonal using a random correlation threshold. The signal may be an ultrawide bandwidth signal.

Preferably, a pseudo-random sequence length is greater than a code word length. The pseudo-random sequence can preferably be reproduced by a predictable method.

In some embodiments K=2^{(B)}, and B is between 2 and 8. In some embodiments K is even and the plurality of codes comprise K/2 code words and K/2 code word inverses.

A method is also provided of decoding a signal using M-ary orthogonal keying. The method comprises: receiving a code; correlating the received code with K possible codes to generate first through Kth correlation values, the K possible codes each representing one of a plurality of possible B-bit sequences; determining a received B-bit sequence by comparing the first through Kth correlation values; and outputting the received B-bit sequence. B is preferably an integer greater than 1 and K is preferably an integer greater than 3. The K code words are all preferably either mutually orthogonal, or nearly orthogonal using a random correlation threshold. The signal may be an ultrawide bandwidth signal.

The step of determining the received B-bit sequence may further comprise: comparing the first through Kth correlation values to determine which of the K possible codes corresponds to the received code; and assigning as the received B-bit sequence the one of the possible B-bit sequences that is represented by the one of the K possible, codes corresponding to the received code.

In some embodiments K=2^{(B)}, and B is between 2 and 8.

The method may further comprise: determining one or more confidence values that indicate a confidence level in the accuracy of the step of determining a received B-bit sequence; and outputting the confidence value.

A method is also provided of decoding a signal using M-ary orthogonal keying. The method comprises: receiving a scrambled code; multiplying the scrambled code by a pseudo-random sequence to generate a descrambled code, the descrambled code being one of a plurality of K possible codes that each represent one of a plurality of possible B-bit sequences; correlating the descrambled code with the K possible codes to generate first through Kth correlation values; determining a received B-bit sequence by comparing the first through Kth correlation values; and outputting the received B-bit sequence. B is preferably an integer greater than 1 and K is preferably an integer greater than 3. The K code words are all preferably either mutually orthogonal, or nearly orthogonal using a random correlation threshold. The signal may be an ultrawide bandwidth signal.

The step of determining the received B-bit sequence may further comprise: comparing the first through Kth correlation values to determine which of the K possible codes corresponds to the descrambled code; and assigning as the received B-bit sequence the one of the possible B-bit sequences that is represented by the one of the K possible codes corresponding to the descrambled code.

The pseudo-random sequence length is preferably greater than a code word length. The pseudo-random sequence can preferably be reproduced by a predictable method.

In some embodiments K=2^{(B)}, and B is between 2 and 8.

The method may further comprise: determining one or more confidence values that indicate a confidence level in the accuracy of the step of determining a received B-bit sequence; and outputting the confidence value.

A method is also provided of decoding a signal using M-ary orthogonal keying. The method comprises: receiving a code; correlating the received code with K possible code words to generate first through Kth correlation values; determining a received B-bit sequence by comparing the first through Kth correlation values; and outputting the received B-bit sequence. The K possible code words and inverses of the K possible code words each preferably represent one of a plurality of possible B-bit sequences. B is preferably an integer greater than 1 and K is preferably an integer greater than 1. The K code words are all preferably either mutually orthogonal, or nearly orthogonal using a random correlation threshold. The signal may be an ultrawide bandwidth signal.

The step of determining the received B-bit sequence may further comprise: comparing the first through Kth correlation values to determine which of the K possible code words or K possible inverse code words corresponds to the received code; and assigning as the received B-bit sequence the one of the possible B-bit sequences that is represented by the one of the K possible code words or K possible inverse code words corresponding to the received code.

In some embodiments K=2^{(B)}, and B is between 2 and 8.

The method may further comprise: determining one or more confidence values that indicate a confidence level in the accuracy of the step of determining a received B-bit sequence; and outputting the confidence value.

A method is also provided of decoding a signal using M-ary orthogonal keying. The method comprises: receiving a scrambled code; multiplying the scrambled code by a pseudo-random sequence to generate a descrambled code, the descrambled code being one of a plurality of K possible code words or inverses of the K possible code words; correlating the descrambled code with the K possible code words to generate first through Kth correlation values; determining a received B-bit sequence by comparing the first through Kth correlation values; and outputting the received B-bit sequence. The K possible code words and the K possible inverse code words each preferably represent one of a plurality of possible B-bit sequences. B is preferably an integer greater than 1 and K is an integer greater than 1. The K code words are all preferably either mutually orthogonal, or nearly orthogonal using a random correlation threshold. The signal may be an ultrawide bandwidth signal.

The step of determining the received B-bit sequence may further comprise: comparing the first through Kth correlation values to determine which of the K possible code words or K possible inverse code words corresponds to the descrambled code; and assigning as the received B-bit sequence the one of the possible B-bit sequences that is represented by the one of the K possible code words or K possible inverse code words corresponding to the descrambled code.

The pseudo-random sequence length is preferably greater than a code word length. The pseudo-random sequence can preferably be reproduced by a predictable method.

In some embodiments K=2^{(B)}, and B is between 2 and 8.

The method may further comprise: determining one or more confidence values that indicate a confidence level in the accuracy of the step of determining a received B-bit sequence; and outputting the confidence value.

### BRIEF DESCRIPTION OF THE DRAWINGS

A more complete appreciation of the invention and its many attendant advantages will be readily obtained as it becomes better understood with reference to the following detailed description when considered in connection with the accompanying drawings, in which:

FIG. 1 is a graph of a typical UWB pulse stream;

FIG. 2 is a graph showing the power spectral density limits currently put in force by the FCC;

FIGS. 3A and 3B are graphs showing exemplary pulse streams for on-off keying, positive pulse amplitude modulation, and binary phase-shift keying, respectively;

FIGS. 4A-4C are constellation diagrams for the modulation schemes of FIGS. 3A-3C, respectively;

FIGS. 5A-5C are constellation diagrams for pulse position modulation schemes under various conditions for binary pulse position modulation schemes, based on the pulse shown in FIG. 1;

FIGS. 6A-6D are graphs showing component pulses for the decomposition of binary PPM into unmodulated and antipodal pulse trains;

FIG. 7 is a timing diagram showing a one-pulse code word according to a preferred embodiment of the present invention;

FIG. 8 is a timing diagram showing a five-pulse code word according to a preferred embodiment of the present invention;

FIG. 9 is a block diagram of a transmitter and receiver pair according to a preferred embodiment of the present invention;

FIG. 10A is a block diagram of the correlator of FIG. 9 having one arm according to a preferred embodiment of the present invention;

FIG. 10B is a block diagram of the correlator of FIG. 9 having two arms according to a preferred embodiment of the present invention;

FIG. 10C is a block diagram of the correlator of FIG. 9 having more than two arms according to a preferred embodiment of the present invention;

FIG. 11 is a block diagram showing a UWB system using pseudo-random scrambling, according to a preferred embodiment of the present invention;

FIG. 12 is a block diagram of a data packet according to a preferred embodiment of the present invention; and

FIGS. 13 and 14 are flow charts describing the operation of the transmitter and receiver, respectively, according to a preferred embodiment of the present invention.

### DETAILED DESCRIPTION OF THE PREFERRED EMBODIMENTS

Preferred embodiments of the present invention will now be described with reference to the drawings. Throughout the several views, like reference numerals designate identical or corresponding parts.

Binary Systems

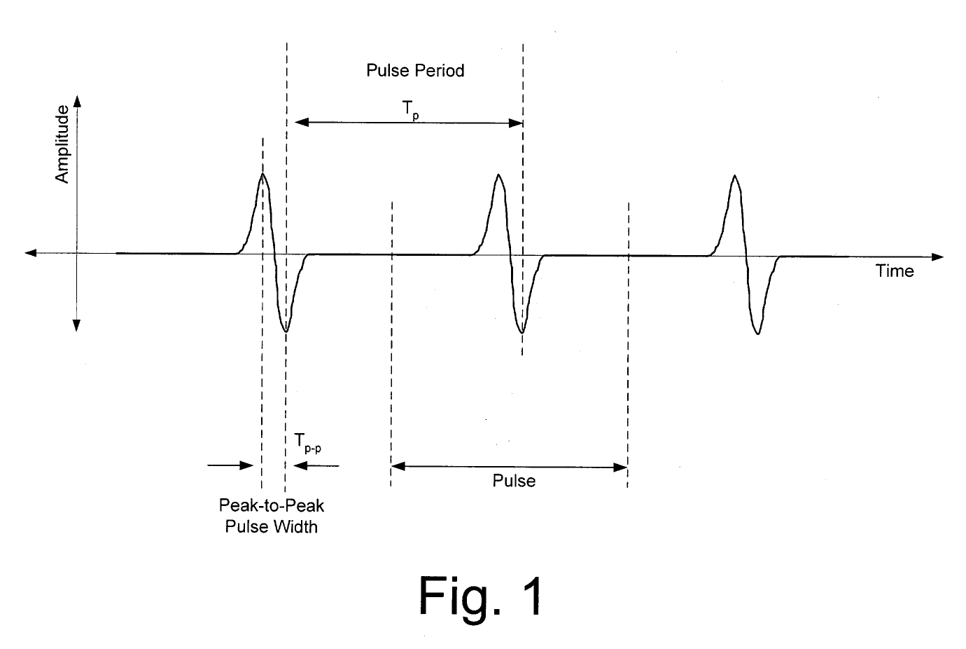

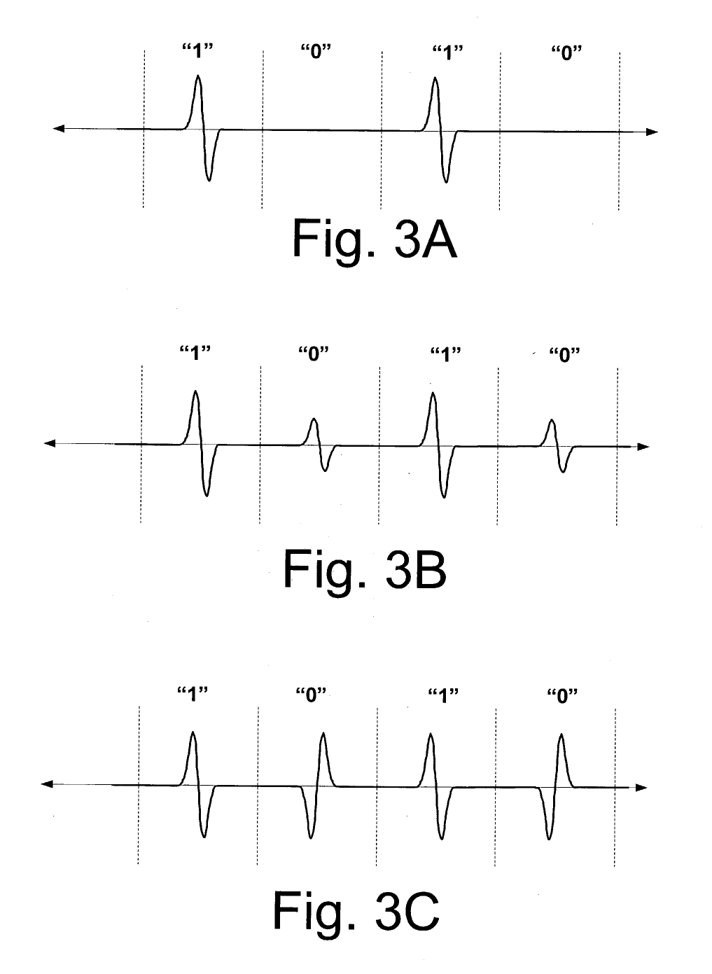

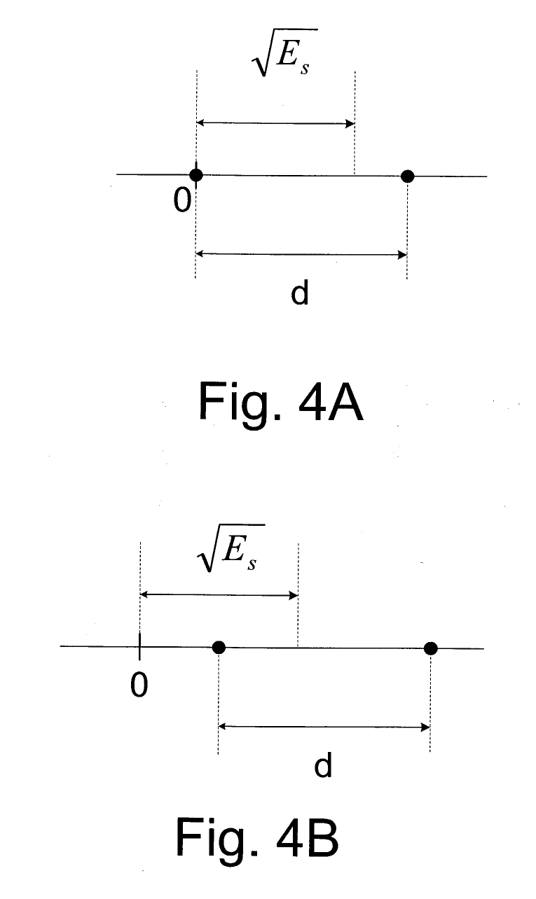

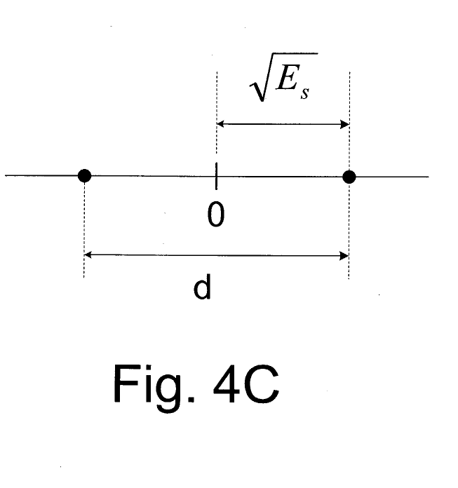

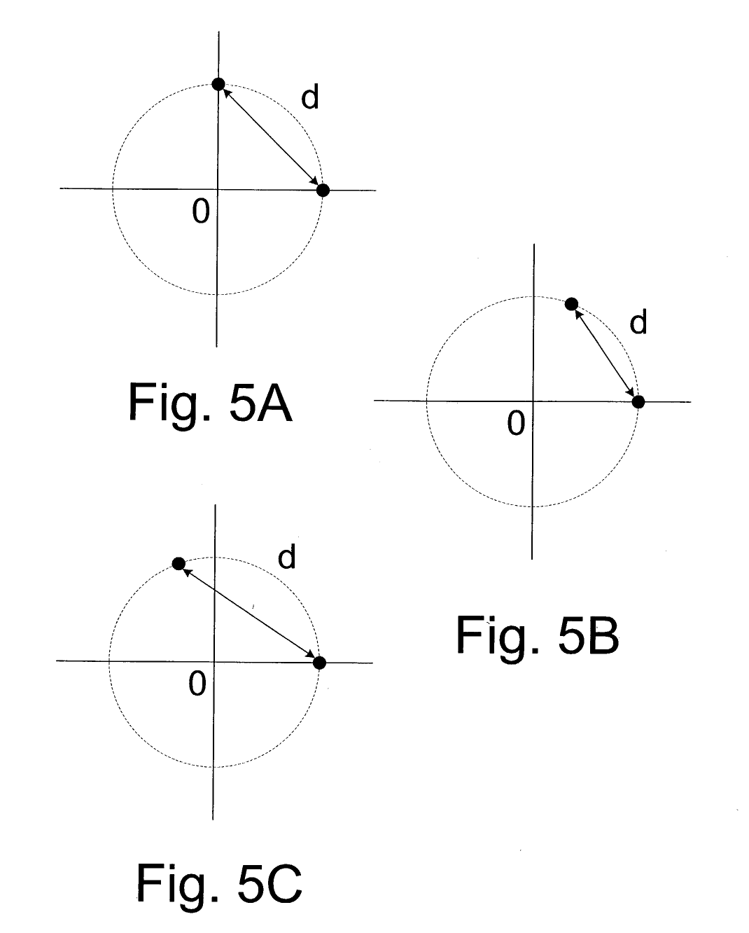

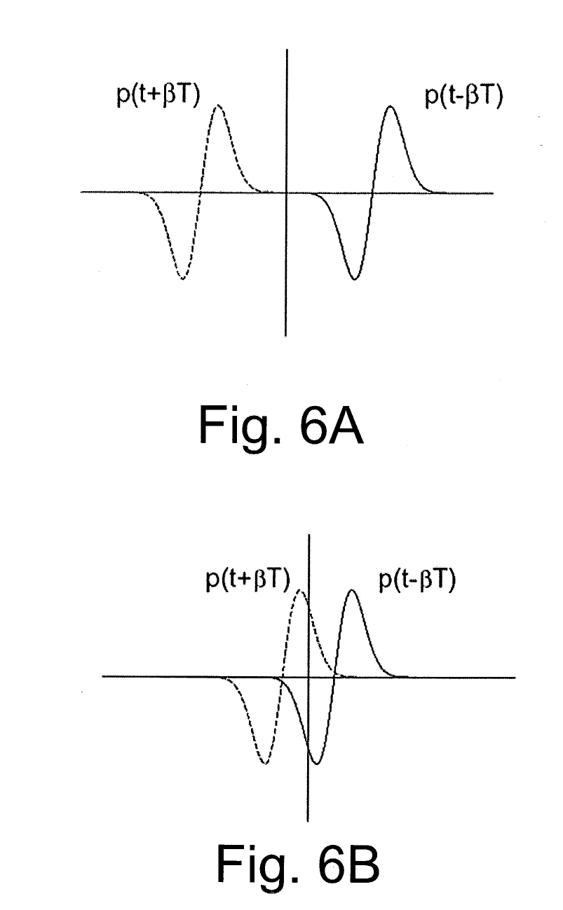

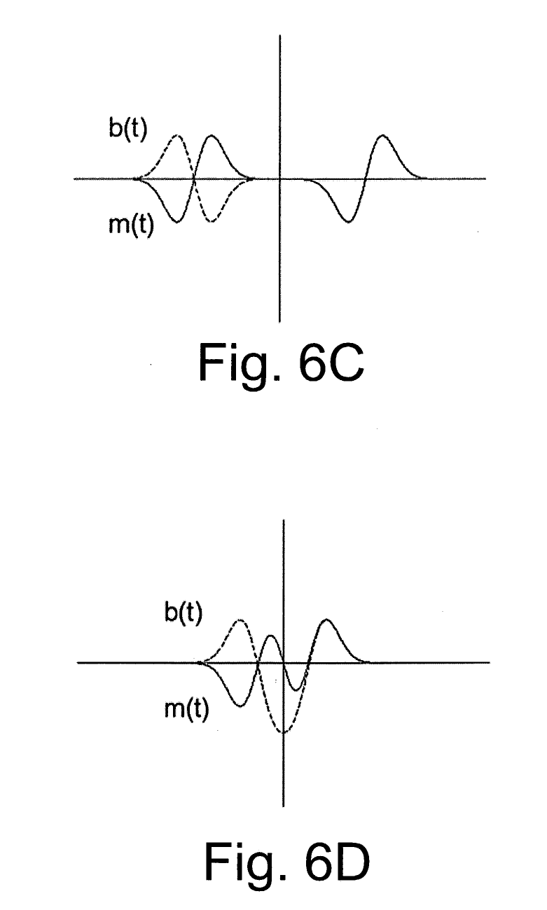

As noted above with respect to FIG. 1, in one embodiment of a UWB system, a series of pulses are sent across a transmission medium. In order to carry data, these UWB pulses need to have data encoded (i.e., modulated) into them. Then a receiver can look at the incoming pulses and decode the original data. As noted above with respect to FIGS. 3A-3C and 6A-6D, a number of different approaches have been tried, including various PAM and PPM schemes.

PPM shifts the position of individual pulses depending upon whether the pulse needs to represent a “1” or a “0.” As shown, for example, in FIG. 6A, in a simple PPM scheme a pulse is moved from a default position by a distance βT to the left if it represents a “0” and is moved from the default position by a distance βT to the right if it represents a “1.”

In this method, the pulses don't change, they just advance or delay in time, i.e., the position of these pulses is modulated in time. In fact, the pulses are generally identical, which makes it easier to generate them. In FIG. 6A the pulses all rise first and then fall.

As noted with respect to FIG. 3C, BPSK does not shift the position of the pulses, but rather inverts the pulses to pass data. As shown in the embodiment of FIG. 3C, a pulse is unaltered if it represents a “0” and is inverted if it represents a “1.” In either case the position of the pulse remains unchanged.

In most cases, BPSK signals will be superior to PPM signals. One primary reason is how the two methods handle noise. When a signal gets sent from a transmitter to a receiver, it is subjected to a certain amount of noise. This noise rides on top of the data signal and can distort the signal. Some of the noise comes from going through the channel (i.e., the transmission medium). Additional noise comes from the receiver, which has to amplify a very small signal. Such an amplification process inherently introduces noise.

The way to compare individual transmission schemes is to determine the maximum amount of noise allowable before the system exceeds a maximum error rate, In any transmission system some errors will occur, due to noise and other reasons. A given system will set a maximum allowable error rate, which it is designed to compensate for. Beyond this error rate, the system will not achieve a desired level of performance. An exemplary maximum error rate, often called a bit error rate (BER), is one error in a thousand, often described as having a BER of 10⁻³.

In the same noise environment, a PPM signal will require twice as much transmit power to achieve the same BER as a BPSK signal. Another way of saying this is that the BPSK signal is superior to the PPM signal by 3 dB (i.e., by a factor of two in power). In other words, for the same amount of power, the BPSK signal will tolerate more noise than a PPM signal. And to tolerate the same amount of noise, the PPM signal would require more power than the BPSK signal.

This analysis assumes Gaussian noise. If the noise were non-Gaussian, the benefits of a BPSK signal might vary (either higher or lower), or might remain the same.

An alternate transmission scheme would be pulse amplitude modulation (PAM), which encodes data through the use of pulses with different amplitude, as described with respect to FIG. 3B. As shown in the embodiment of FIG. 3B, a small pulse is sent to represent a “0” and a large pulse is sent to represent a “1.” Regardless, the pulses preferably remain a standard distance from each other.

These are all binary systems, i.e., they encode data as a string of ones and zeroes.

M-ary Systems

The analysis in the Background of the Invention was restricted to binary modulation techniques appropriate for UWB signal generation. There are also a number of ways in which these binary techniques could be extended to larger symbol constellations. A few specific exemplary forms are discussed below.

Such alternative transmission schemes may be called M-ary systems. In this case, M-ary simply means that there are M different choices for encoding data. A binary system is actually an M-ary system where (M=2), i.e., a 2-ary system. Alternate systems could have M equal to four (4-ary), M equal to eight (8-ary), or any other acceptable number. Powers of two are preferable for M since it makes implementation easier, but are not required.

In an M-ary system, each pulse has M different ways that it can be sent to the receiver. For example an M-ary PAM system (called an MPAM system) would have M different pulse voltages that can be used.

An analysis of M-PAM shows that higher order PAM modulation leads to less power efficiency. This is clearly seen by the reduced data rates versus range performance for the larger constellations. However, such a design might be more robust against multipath-induced inter-symbol interference (ISI) due to the longer symbol interval for a given data rate.

The binary PPM technique can also be extended to M-ary orthogonal (or non-orthogonal) PPM by mapping b bits to a single pulse (or pulse train) and using 2^{b} different values for the pulse position. In general M-ary orthogonal signaling will provide better distance properties for higher dimensions, resulting in better power efficiency relative to binary PPM. M-ary PPM can be analyzed by extending the decomposition techniques describe earlier for the binary case. It is known that M-ary orthogonal constellation do have non-zero means and this technique would therefore still result in spectral lines and suboptimal power efficiency.

The most promising extension of binary modulation is to map multiple data bits into bi-orthogonal sequences of bi-phase pulses. This system, called M-ary bi-orthogonal keying (MBOK) involves the mapping of b bits to a group of consecutive bi-phase pulses. MBOK provides improved power efficiency relative to binary antipodal signaling, yet would still not generate spectral lines for white data.

In addition, some of the transmission schemes set forth above could be combined into a single M-ary system. An M-ary BPSK PPAM system could use

$$\frac{M}{2}$$

voltages, with the pulses being either non-inverted or inverted to achieve M possible results. Such a system can be referred to as simply M-PAM, e.g., 8-PAM or 4-PAM. The term M-PAM is generally limited to cases where M>2, since a 2-PAM system would be equivalent to a basic BPSK system.

UWB systems preferably transmit at extremely small power levels, but at very wide bandwidths. Thus, although they generally have essentially as much bandwidth as they want, UWB systems must maintain very low power levels to be efficient. Therefore, it's desirable to choose a modulation scheme that is extremely power efficient.

It turns out that M-PAM modulation is less power efficient than BPSK modulation, for example, consider an 8-PAM transmission scheme. Although it appears that such a scheme would be more efficient (after all, it's transmitting three times as much data in a similar transmission using BPSK), it turns out to be less power efficient than BPSK. The reason for this is that an M-PAM modulation scheme requires much higher power levels for many of its pulses.

However, there are more power efficient alternatives for using a BPSK signal at a given frequency, (i.e., number of pulses per unit time) to send more data.

Increased Frequency

In one embodiment it is possible to simply increase the frequency of the transmitted pulses, (i.e., send more pulses per unit time), rather than use an M-PAM (or other) modulation scheme. This will be effective up to the maximum possible transmission frequency of the UWB signal, i.e., the fastest the system can send pulses.

Therefore, the important questions are: how fast can you run the system clock; and how fast can you sent pulses? In many UWB systems the pulses are on the order of one nanosecond in width. In order to send one hundred megabits per second (MBPS) of data, the system must send one bit of data every ten nanoseconds

Thus, for a transmission rate of 100 MBPS with each bit of data represented by a single pulse, the system need only send a single 1 ns pulse every 10 ns—a reasonable requirement. This can potentially allow for more pulses to be sent, thus increasing the rate of data transmission. However, this is limited by the size of the pulse and the minimum allowable distance between pulses. Once the pulses are so close that they are only that minimum distance from each other, the system can no longer increase the pulse transmission rate without having pulses collide.

Code Word

An alternative to sending data as individual pulses is to instead represent each bit by a series of pulses. This series of pulses can be called a code word. In a binary system, a set of BPSK pulses will preferably be chosen to represent a “0” and its inverse will preferably be chosen to represent a “1.”

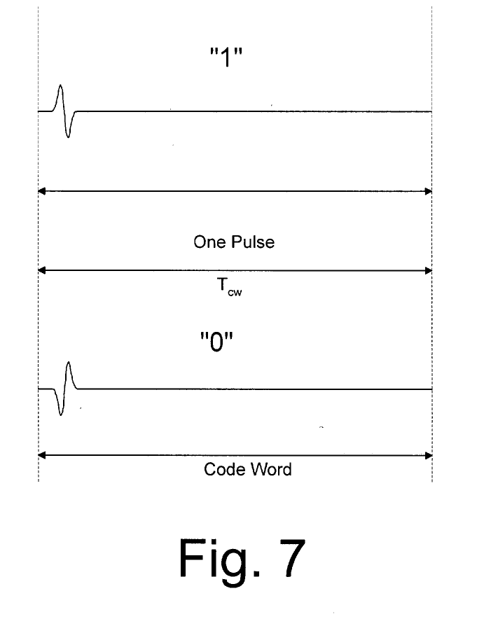

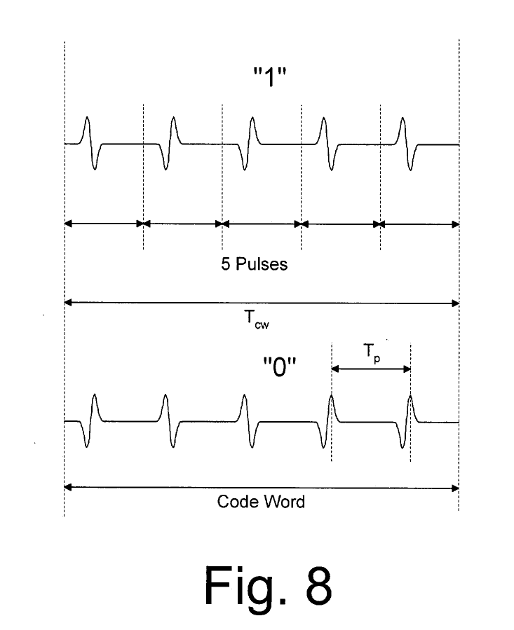

Individual pulses are then ordered together into code words to transfer data at a given data rate, with each code word corresponding to one or more bits of information to be transferred. The code words have a code word period T_{cw}, indicating the duration of an code word, and a related code word frequency F_{cw}. This may correspond to the data rate, though it does not have to. FIGS. 7 and 8 show two examples of code words.

FIG. 7 is a timing diagram showing a one-pulse code word according to a preferred embodiment of the present invention. This simplest example has a code word that includes a single pulse. In this case the code word period T_{cw} and the pulse period Tₚ are the same (i.e., the pulses and the code words are transmitted at the same frequency). As shown in FIG. 7, the non-inverted pulse corresponds to a “1,” and the inverted pulse corresponds to a “0.” This could be reversed for alternate embodiments.

FIG. 8 is a timing diagram showing a five-pulse code word according to a preferred embodiment of the present invention. This embodiment has a code word that includes five pulses. In this case the code word period T_{cw} is five times the pulse period Tₚ (i.e., the code words are transmitted at one-fifth the frequency of the pulses).

In other words:

T_{cw}=n*Tₚ (15)

for an n-pulse code word. Thus, the pulse period Tₚ and number of pulses n per code word determine the period of the code word T_{cw}.

As shown in FIG. 8, a particular orientation of the five pulses corresponds to a “1,” and the inverse of this orientation corresponds to a “0.” The particular choice of pulse orientation and arrangement within the code word is not critical, and can be varied as necessary. What is important is that the “1” and “0” code words are the inverse of each other.

One preferred embodiment includes 13 analog pulses per code word, and sets the pulse frequency Fₚ at 1.3 GHz (770 ps pulse period Tₚ). This results in a code word frequency F_{cw} of 100 MHz (10 ns code word period T_{cw}), which corresponds to a data transfer rate of 100 Mbits of information per second.

The various parameters of peak-to-peak pulse width Tₚ₋ₚ, pulse period Tₚ, pulse frequency Fₚ, number of pulses per code word n, code word period T_{cw},and code word frequency F_{cw} can be varied as necessary to achieve the desired performance characteristics for the transceiver. For example, the embodiments disclosed in FIGS. 7 and 8 have the same code word period T_{cw}, despite the differing number of pulses n. This means that the transmission power for a given code word period T_{cw} is used in a single pulse in the embodiment of FIG. 7, but is spread out over five pulses in the embodiment of FIG. 8. Alternate embodiments can obviously change these parameters as needed.

Thus, in the embodiment of FIG. 7, when a transmitter passes a bit of data to a receiver, the transmitter sends the bit as a code word (i.e., a set series of pulses). As noted above, the bits are preferably represented by inverse code words such that the non-inverted code word represents a “1” and the inverted code word represents a “1.” However, in alternate embodiments this assignment of code word/inverse code word to “1” and “0” values can be reversed.

In addition, Although FIG. 8 shows a code word having five pulses, this number can be varied as needed. Alternate embodiments can use any code word length that allows system requirements to be met. For example, as clock speeds increase, the number of pulses that can be sent in a given time will increase and longer code word lengths may be used.

One advantage with using a code word is that you can spread out a required transmission power over multiple pulses. For a successful transmission, it's necessary to use a certain amount of energy to send each bit. If the bit is sent in a single pulse, that pulse has to include all of the required energy. This requires a larger pulse and increases the peak-to-average ratio of the signal (i.e., the entire waveform). However, if five pulses are used to send a single bit of data (as shown in the embodiment of FIG. 8), the energy can be spread out among five separate pulses. Thus, each individual pulse can be smaller and can have a lower peak-to-average ratio.

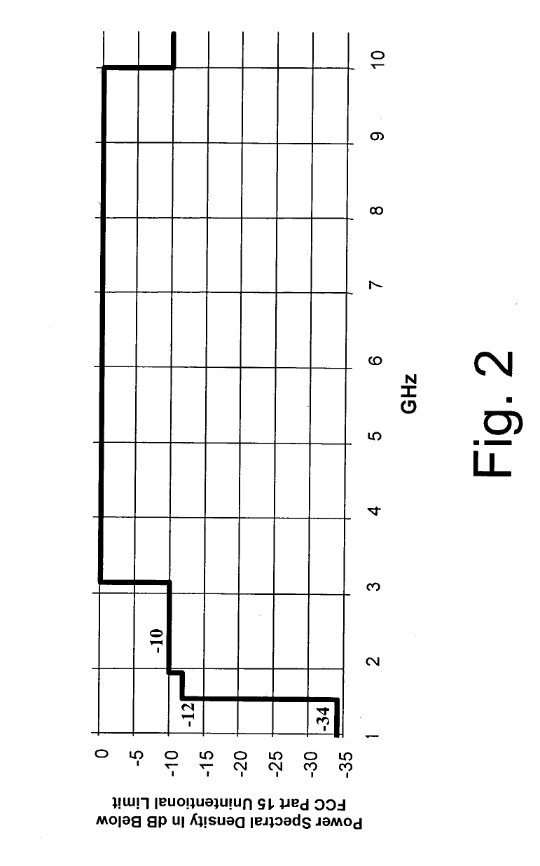

However, using a multiple pulse code word to represent a bit will alter the spectrum of the transmitted signal. And given rules currently promulgated by the Federal Communications Commission (FCC), UWB signals must meet certain power constraints. (See FIG. 2)

As shown in FIG. 2, UWB signals must fall below a set power maximum for any given frequency. In other words, the energy of the UWB signal cannot exceed the set power maximum at any frequency. Therefore, it is necessary that the UWB signal fit within the power spectrum density requirements set forth in FIG. 2.

For a UWB signal, the amount of energy sent in a transmission is equal to the area under its power spectrum density curve. For the best possible system performance, it's preferable that this area be maximized. In other words, it is desirable to have a signal whose properties fits under the restricted curve, but is arranged to have a maximum possible area.

When a UWB system uses a sequence of pulses to send a bit of data, the power spectrum density ends up looking wavy, with numerous peaks and valleys. The exact waviness of the power spectrum density depends upon the particular sequence of pulses used.

The peaks in the PSD curve can limit the transmission power by limiting the maximum total power transmitted. Since the power spectrum density cannot ever go above the power maximum set by the FCC, the maximum point of the power spectrum density curve can be no higher than the allowable power maximum. If there are too many peaks (and corresponding valleys) in the power spectrum density curve (or even just one big one), the overall area under the power spectrum density curve can be significantly reduced by the presence of one or more large valleys, indicating a lower overall transmission power for the UWB signal. Thus, a smoother power spectrum density curve is preferable because that maximizes the area under the curve.

As it turns out, the more regular the transmitted pulse pattern (i.e., the more predictable patterns are formed in the signal), the greater the number and size of the peaks and valleys in the curve. But if the transmitted pulses appear random (i.e., they have no discernable pattern of “1”s and “0”s), a smoother curve results. And since we want to get as much performance as we can from our assigned channel, it is desirable to use a signal that is smooth. This allows the signal to use a greater amount of power without violating the FCC's PSD constraints.

Scaling Up Transmission Rate

In addition, one constant pressure in any transmission scheme, UWB included, is the desire to scale the transmission rate upward, (i.e., send more data bits faster). Fir example, instead of sending a hundred megabits, we want to send hundreds of megabits.

There are several ways that the data rate can be sped up. One way is to send more pulses through within the same period of time. This would involve either reducing the width of the individual pulses or reducing the spacing between adjacent pulses.

Another way is to use a smaller code word. As you drop pulses off of the code word, the code word takes less time to transmit and thus allows more to be sent in a given time.

Yet another alternative is to use multiple code words to represent more than just a binary bit of data. Rather than just using a code word and its inverse, you could use multiple different code words, each representing a different combination of multiple bits. For example, if the code word is five pulses long, there are thirty-two different ways that inverted and non-inverted pulses can be combined to form a code word. Counting for the fact that half of these will be the inverse of others, this allows for sixteen possible code words. This potentially allows up to five bits of data to be sent in the time it takes for five pulses to be sent. The receiver can determine which bits of data have been sent by determining which combination of inverted and non-inverted pulses have been received as the code word.

More generally, this system allows for log₂(C) bits to be sent, where C is the number of code words used. In the example above, if all 32 code words were used, then log₂(32), or 5 bits could be sent.

However, there are some increased implementation costs with increasing the number of different code words used. Because each receiver has to look for each of the multiple code words used rather than just one, they must each include additional circuitry to do so.

System for M-ary Bi-Orthogonal Keying

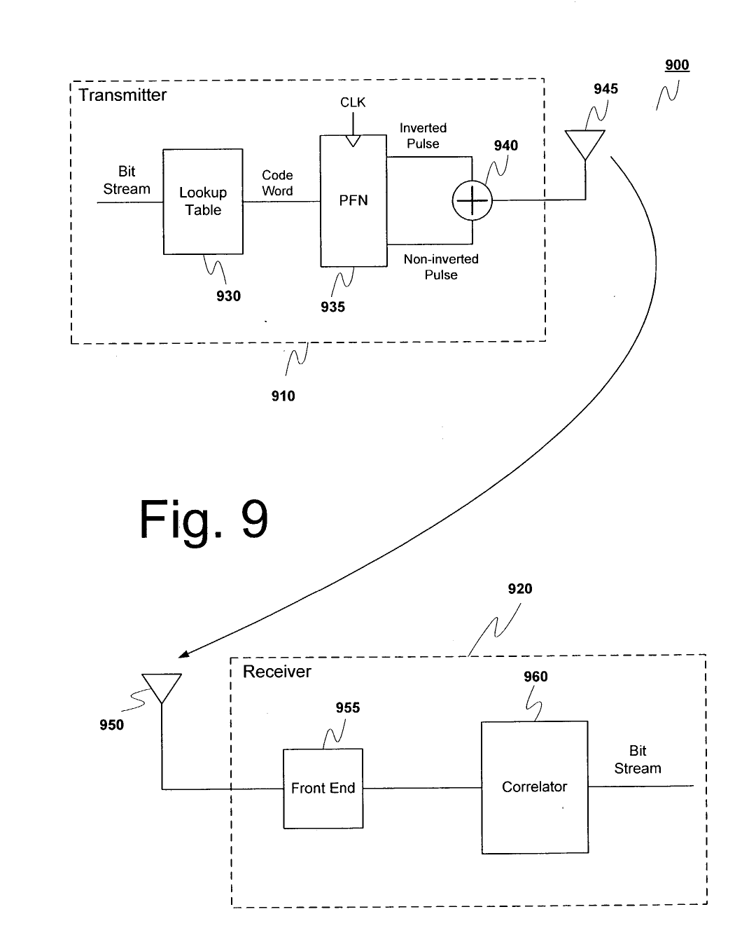

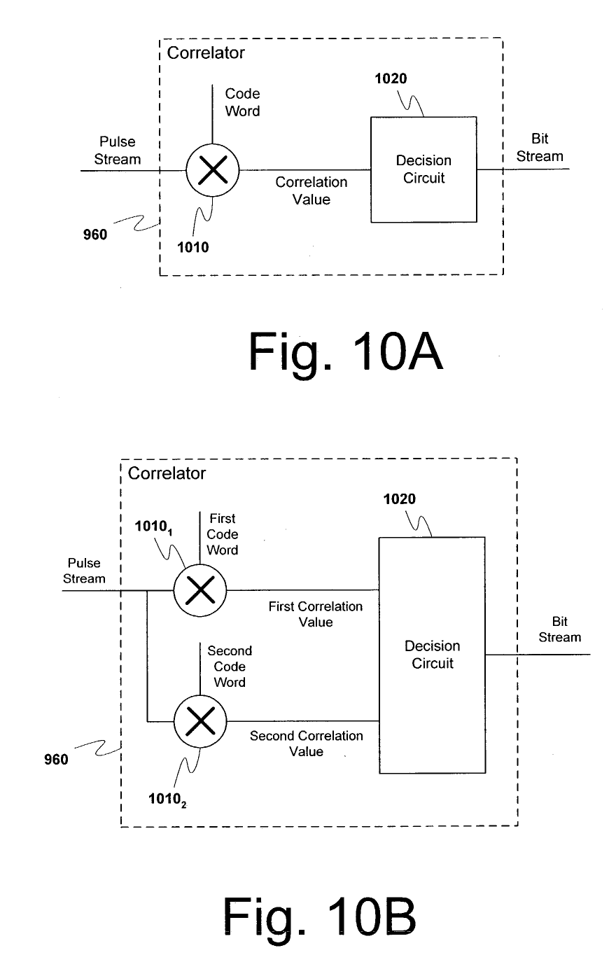

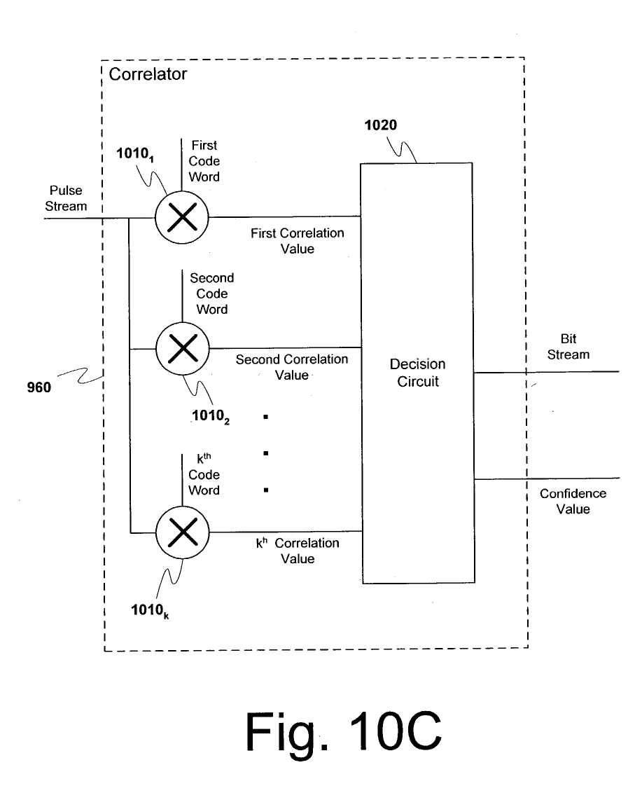

FIG. 9 is a block diagram of a transmitter and receiver pair according to a preferred embodiment of the present invention. As shown in FIG. 9, the transmitter receiver pair includes a transmitter 910 and a receiver 920. The transmitter 910 includes a lookup table 930, a pulse forming network (PFN) 935, an adder 940, and a transmitting antenna 945. The receiver 920 includes a receiving antenna 950, a front end 955, and a correlator 960.

Transmitter

The lookup table 930 receives a bit stream, breaks the bit stream up into n-bit groups, and determines the proper code word associated with that particular n-bit group. It then sequentially outputs a series of “1”s and “0”s corresponding to the proper code word. In this embodiment n can be any integer greater than 0. Although this preferred embodiment uses a lookup table 930, alternate embodiments could use other circuitry to perform this same function.

The PFN 935 receives the string of “1”s and “0”s that define the code word from the lookup table 930 and outputs either a non-inverted or an inverted pulse in response to each input value. In the preferred embodiment, the PFN 935 receives a clock signal CLK and a code word as inputs, and has non-inverted and inverted outputs. Whenever the clock CLK cycles, the PFN 935 outputs either a non-inverted pulse at the non-inverted output, or an inverted pulse at the inverted output, depending upon the value of the individual bits in the code word.

The adder 940 then adds together the inverting and non-inverting outputs (only one of which should be active at a time) to provide a single output pulse. This output pulse will be either a positive (non-inverting) pulse or a negative (inverted) pulse, depending upon the value of the current bit of the code word when the clock CLK cycles. Alternate embodiments of the PFN 935 could have a single output that outputs either an inverted or non-inverted pulse depending upon the value of the current bit of the code word. In such embodiments there is no need for the adder 940.

The output of the adder 940 is then sent to the transmitting antenna 945, which transmits the pulses to the receiver 920.

Receiver

The receiving antenna 950 receives the pulses in a signal sent by the transmitting antenna 945 in the transmitter 910.

The front end 955 preferably performs necessary operations on the received signal to better allow the remainder of the receiver 920 to properly process it. This can include performing filtering and amplifying the signal.

The correlator 960 receives a code word from the front end, determine what n-bit group corresponds to that code word (or inverse code word) and outputs the corresponding n-bit group. The correlator 960 will have to have as many different branches (called arms or fingers) to look for code words as there are individual code words.

Single Code Word

In its simplest implementation, a single code word can be used to send a bit stream from the transmitter 910 to the receiver 920 one bit of data at a time. The transmitter 910 takes the bit stream, separates the stream into individual bits, chooses a code word/code word inverse based on the bit to be transmitted, and then sends the chosen code word/inverse to the receiver 920.

The correlator 960 in the receiver 920 then needs to check each incoming n-bits to see if they correspond to the code word or its inverse. Since the correlator 960 needs to look for only one code word, it needs only one arm (i.e., only one set of circuitry devoted to correlating a code word).

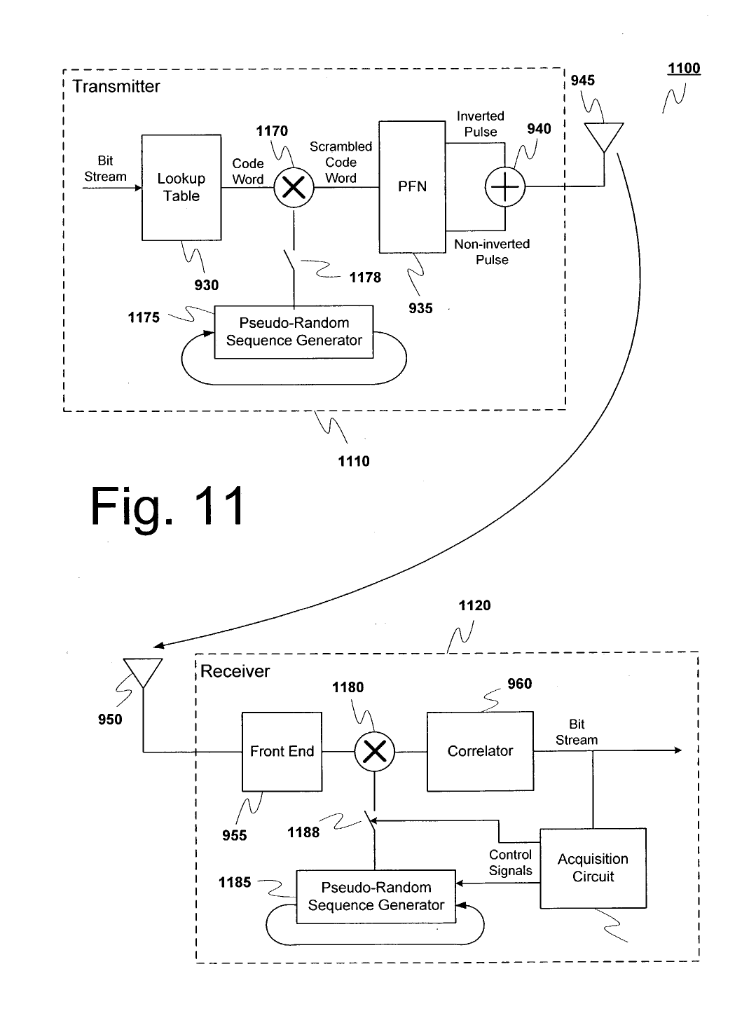

FIG. 10A is a block diagram of the correlator of FIG. 9 having one arm according to a preferred embodiment of the present invention. As shown in FIG. 10A, the correlator 960 includes a mixer 1010 and a decision circuit 1020. The mixer 1010 receives the incoming signal and the code word. It mixes the code word CW and a portion of the incoming signal equal in length to the code word and outputs a correlation result. This correlation result will be a large number if the code word is matched or a large negative number if the inverse of the code word is matched. By examining the correlation result, the decision circuit 1020 determines what data bit the code word corresponds to (i.e., a “1” or a “0”), and outputs that data bit to other circuitry in the receiver 920.

The single input stage (i.e., the mixer 1010) on the correlator 960 corresponds to the correlators 960 one arm.

Multiple Code Words

However, as noted above, multiple code words can be used to send multiple bits at the same time. For example, to send two data bits at a time, two different code words should be used. Each code word then represents two bits of data. In this case, if the bit stream to be transmitted were 0111001101001001, the transmitter would break it up into two bit section as so: (01)(11)(00)(11)(01)(00)(10)(01).

These two bits each represent four different choices, which correspond to the two code words and their inverses. One way this can be implemented is to have the first bit determine which code word will be used, and have the second bit determine whether the chosen code word or its inverse should be used. This exemplary implementation is shown in Table 2.

TABLE 2
Choice of Code Words by Bit Sequence

| Bit Sequence | Code word |
|---|---|
| 00 | First code word |
| 11 | Inverse of first code word |
| 01 | Second code word |
| 10 | Inverse of second code word |

The transmitter 910 takes the bit stream to be sent to the receiver 920, separates the stream into 2-bit sections, chooses a code word/code word inverse based on the two bits to be sent, and sends the chosen code word/inverse to the receiver 920.

The correlator 960 in the receiver 920 then needs to check each incoming n-bits to see if they correspond to the first or second code word or their inverses. Since the correlator 960 needs to look for two code words, it needs two arms (i.e., two sets of circuitry devoted to correlating a code word).

FIG. 10B is a block diagram of the correlator of FIG. 9 having two arms according to a preferred embodiment of the present invention. As shown in FIG. 10B, the correlator 960 includes first and second mixers 1010₁ and 1010₂ and a decision circuit 1020. The mixers 1010₁ and 1010₂ each receive the incoming signal and one of the two code words CW₁ or CW₂. Each mixer 1010₁, 1010₂ mixes the respective code word and a portion of the incoming signal equal in length to the code words and outputs a respective correlation result. Each correlation result will be a large number if the code word is matched, a large negative number if the inverse of the code word is matched, or a lower value if neither the code word nor its inverse is matched.

By examining the first and second correlation results, the decision circuit 1020 determines what two data bits the code word corresponds to (i.e., “00,” “01,” “10,” or “11”), and outputs those two data bits to other circuitry in the receiver 920. This examination can be performed, for example, by setting a threshold for correlation values, above which a correlation is considered successful, by comparing all of the correlation values and picking the largest result as a successful correlation, or a combination of the two.

The double input stage (i.e., mixers 1010₁ and 1010₂) on the correlator 960 corresponds to the correlators 960 two arms.

This can be extended beyond the use of two codes. In its general form, a system that sends b bits of data must use (k=2^{(b-1)}) code words. As the number of code words is increased, however, the receiver still remains relatively simple, merely requiring k arms on its correlator 960. The receiver 920 still does not have to look for individual pulses but instead looks for the k different code words in n-pulse increments.

The transmitter 910 takes the bit stream to be sent to the receiver 920, separates the stream into n-bit sections (where n is greater than 2), chooses a code word/code word inverse based on the n bits to be sent, and sends the chosen code word/inverse to the receiver 920.

The correlator 960 in the receiver 920 then needs to check each incoming n-bits to see which of the first through k^{th} code words (or inverses) they correspond to. Since the correlator 960 needs to look for k code words, it needs k arms (i.e., k sets of circuitry devoted to correlating a code word).

FIG. 10C is a block diagram of the correlator of FIG. 9 having more than two arms according to a preferred embodiment of the present invention. As shown in FIG. 10C, the correlator 960 includes first through k^{th} mixers 1010₁ to 1010ₖ, and a decision circuit 1020. The mixers 1010₁ to 1010ₖ each receive the incoming signal and one of the n code words CW₁ to CWₖ. Each mixer 1010₁, . . . , 1010ₖ mixes the respective code word and a portion of the incoming signal equal in length to the code words and outputs a respective correlation result. Each correlation result will be a large number if the respective code word is matched, a large negative number if the inverse of the respective code word is matched, or a lower value if neither the respective code word nor its inverse is matched.

By examining the first through k^{th} correlation results, the decision circuit 1020 determines what b data bits the code word corresponds to, and outputs those b data bits to other circuitry in the receiver 920. This examination can be performed, for example, by setting a threshold for correlation values, above which a correlation is considered successful, by comparing all of the correlation values and picking the largest result as a successful correlation, or a combination of the two.

The multiple input stage (i.e., mixers 1010₁ through 1010ₖ) on the correlator 960 corresponds to the correlators 960 k arms.

In each embodiment the correlator 960 preferably looks for the code words rather than individual pulses. If the correlator 960 looked for each individual pulse, it would have to make a lot more decisions, since it would check a larger number of individual pulses. The complexity of the system can be significantly reduced by having the correlator 960 look instead for a long sequence of pulses.

When multiple code words are used, the choice of how the code words are formed becomes important. Although for any given code word size n, there are 2⁽ⁿ⁻¹⁾ possible code words to choose from, it turns out that some code words are better than others. One reason for this is the operation of the correlator 960 in the receiver 920.

When multiple code words are used, the correlator 960 has multiple arms (i.e., multiple mixers 1010₁ to 1010ₖ). The decision circuit 1020 has to take the first through k^{th} correlation results from these mixers 1010₁ to 1010ₖ and compare them to determine which code word (or inverse) was received. By choosing code words that are orthogonal to each other, the function performed by the decision circuit 1020 can be greatly simplified.

As noted above, when a particular code word (or its inverse) sent from the transmitter 910 is received by the i^{th} mixer 1010ᵢ and is mixed with the respective code word CWᵢ, the i^{th} mixer 1010ᵢ will output a large positive number if the received code word matches the i^{th} code word, and will output a large negative number if the received code word matches the inverse of the i^{th} code word.

If the code words are not orthogonal to each other, then if the received code word does not match the i^{th} code word CWᵢ, the i^{th} mixer will output a non-zero value somewhere between the large negative number and the large positive number. However, if the code words are orthogonal to each other, then if the received code word does not match the i^{th} code word CWᵢ, the i^{th} mixer will output a value of zero.

One way the decision circuit 1020 can decide which correlation value is the correct one (i.e., which indicates the proper code word) is that it examines all of the outputs of the receiver mixers 1010₁ to 1010ₖ and looks for the one that has the largest absolute value. Ideally, the other receiver multipliers should have an output close to zero.

This indicates which of the code words has been received, but not whether it was inverted or not inverted. For this the decision circuit 1020 looks at the sign of the chosen correlation value. If it is positive, then the non-inverted code word has been received; if it is negative, then the inverted code word has been received.

By using orthogonal code words, the system allows the receiver to make a much easier comparison of correlation values, since when the code words are orthogonal, one correlation value will be a large positive or negative number (i.e., the one corresponding the received code word), and all of the other correlation values will be zero (or close to zero, accounting for the presence of noise in the system). Thus, then when the absolute value of the output of the correlator corresponding to the received code word is at a maximum, the output of the other correlators will be zero.

Thankfully, orthogonal code sets are not difficult to find. For example, if you have a code word of twelve pulses, (i.e., a length twelve code word), you would have 2¹² or 4096 possible code words. From this set of 4096 possible code words there is at least one set of twelve codes that are mutually orthogonal, as shown in Table 3. Other orthogonal subsets also exist.

TABLE 3
Orthogonal Code Word
Set for Length 12 Code Word

| Code | | | | | | | | | | | | |
|---|---|---|---|---|---|---|---|---|---|---|---|---|
| Word | B₀ | B₁ | B₂ | B₃ | B₄ | B₅ | B₆ | B₇ | B₈ | B₉ | B₁₀ | B₁₁ |
| 1 | −1 | 1 | 1 | 1 | 1 | 1 | −1 | −1 | −1 | 1 | 1 | −1 |
| 2 | −1 | −1 | −1 | −1 | −1 | −1 | −1 | −1 | −1 | −1 | 1 | −1 |
| 3 | −1 | −1 | −1 | −1 | 1 | 1 | −1 | −1 | 1 | 1 | −1 | 1 |
| 4 | −1 | −1 | −1 | 1 | −1 | 1 | 1 | 1 | −1 | 1 | −1 | −1 |
| 5 | −1 | −1 | 1 | −1 | 1 | −1 | 1 | 1 | −1 | 1 | 1 | 1 |
| 6 | −1 | −1 | 1 | 1 | −1 | 1 | −1 | 1 | 1 | −1 | 1 | 1 |
| 7 | −1 | −1 | 1 | 1 | 1 | −1 | 1 | −1 | 1 | −1 | −1 | −1 |
| 8 | −1 | 1 | −1 | −1 | 1 | 1 | 1 | 1 | 1 | −1 | 1 | −1 |
| 9 | −1 | 1 | −1 | 1 | −1 | −1 | 1 | −1 | 1 | 1 | 1 | 1 |
| 10 | −1 | 1 | −1 | 1 | 1 | −1 | −1 | 1 | −1 | −1 | −1 | 1 |
| 11 | −1 | 1 | 1 | −1 | −1 | −1 | −1 | 1 | 1 | 1 | −1 | −1 |
| 12 | −1 | 1 | 1 | −1 | −1 | 1 | 1 | −1 | −1 | −1 | −1 | 1 |

Furthermore, since the system uses not only the chosen orthogonal code words, but also their inverses, there are actually twice as many possible codes to choose from. (Hence the term “bi-orthogonal.”) In the example above where twelve code words were chosen, there will actually be twenty-four possible codes—twelve code words and their inverses.

Thus, if you use a length twelve code word and pick eight of the above twelve orthogonal code words (sixteen total possible values, counting inverses), you can send four bits of data at a time. (16=2⁴)

Stated more generally, if b is the number of data bits you want to send, you need to find a group of 2^{(b-1)} mutually orthogonal code words. Adding their inverses, this will give you 2^{b} total codes, which is sufficient to send b bits of data.

In alternate embodiments you could design an orthogonal system that doesn't use inverses. However, then you would need 2^{b} mutually orthogonal codes to send b bits of data, instead of 2^{(b-1)} mutually orthogonal codes. Thus, you would you need twice as many codes if you don't use their inverses.

In contrast, by using the inverses you can use half as many codes because of the inverses make up the other half. Using inverses also gives slightly better performance and the potential for having no spectral lines.

Within the set of possible code words (2^{p} combinations of pulses, where p is the number of pulses in the code word), there will be numerous different subsets that are mutually orthogonal. Any of these subsets can be used, provided they have enough elements to pass the required number of data bits. Not surprisingly, the larger the number of pulses in the code word and the smaller the number of data bits sent, the easier it will be to find a useful subset of mutually orthogonal codes.

In alternate embodiments it is also possible to use code sets that are nearly orthogonal. Nearly orthogonal refers to code word sets in which the correlation between different code words from the set gives results that are greater than zero, but are smaller than an acceptable threshold.

This threshold can be determined based on the ability of the correlator to differentiate between a correct code word correlation and an incorrect code word correlation. One possible threshold is a random correlation threshold, which corresponds to the expected correlation value that random noise would give. In other words, using this threshold, a set of codes would be considered nearly orthogonal if the correlation between all combinations of different code words in the set give results that are better than the expected correlation between any of the code words and a set of random bits equal in length to the code word. However, alternate embodiments could use a different threshold.

By allowing the use of nearly orthogonal code sets for the code words, the system greatly increases the available choices for code word sets.

Thus, by using multiple code words, it is possible to send data at a greater speed without sending individual pulses any quicker. For example, if four code words are used (allowing three data bits to be sent at a time), a system that would operated at 100 MBPS with one code word could operate at 300 MBPS without significantly increasing the complexity of the transmission circuitry at all. The price that will have to be paid is to put multiple arms into the correlators in each receiver to look for all these code words at the same time.

Benefits Regarding Analog-to-Digital Converters

Another advantage to this design is that by using multiple arms in each correlator 960, the receiver need not increase the complexity of the analog-to-digital converters (ADCs) contained in the correlator 960 as the data rate is increased.

Since the decision circuit 1020 in the correlator 960 receives an analog correlation signal from each mixer 1010ᵢ, and outputs a digital data signal to another portion of the receiver 920, it will have to have at least one ADC to convert the received analog signal to a digital signal.

If the receiver 920 used a single arm in its correlator 960 (i.e., a single mixer 1010 checking for correlation with a single code word), the ADC in the decision circuit 1020 would need to operate at the full data transmission speed. For example, if the receiver 920 was operating at 400 MBPS, the ADC would also have to operate at 400 MBPS—making 400 million decisions every second.

However, if the receiver 920 used four arms in its correlator 960 (i.e., four mixers 1010₁ to 1010₄ to check for four separate code words CW₁ to CW₄ at the same time), then it would require four ADCs in the decision circuit 1020, each operating at 100 MBPS—making only 100 million decisions every second. This makes for a simpler design, since it is easier to design lower speed ADCs. As the speed of ADCs increase they have to have a higher performance, be of higher quality, have less distortion, etc. than a lower speed ADC. This is usually more expensive, may take up more chip area, and may require a more expensive processing technology to create than a larger number of slower ADCs. Generally it is better to use multiple slow ADCs than one fast one.

In alternate embodiments it is also possible to make all of the necessary correlation decisions before any analog-to-digital conversion, thus using only one slow ADC.

Scalability

Furthermore, the concept of multiple code words is scalable, with the only limit being the number of correlators required in the receivers. If you want to send b bits at a time, then you need 2^{(b-1)} code words and therefore 2^{(b-1)} arms in the correlators 960 of each receiver 920.

Currently the number of bits b sent at a time is preferably between 2 and 5, i.e., 4 to 16 arms in each correlator 960. However, as semiconductor fabrication technology advances, the number of workable correlators in a receiver will expand and the number of usable codes will similarly increase.

Power Efficiency

Another advantage of this design is that it has improved power efficiency. By using M-ary bi-orthogonal keying (MBOK), a transmission will suffer fewer errors for the same amount of noise that's present in the system as compared to BPSK or PPM. This results in a coding gain, i.e., a more power efficient modulation scheme. In other words, for the same amount of errors at the receiver 920, the transmitter 910 would use less transmission power. Equivalently for the same amount of transmission power, the receiver 920 would suffer fewer errors.

In a system that has a set number of allowable errors, e.g., 10⁻³ BER, this means that the transmitter 910 can either transmit at a lower power to achieve that BER, or the signal could be sent over a longer distance before it reached its maximum BER because of the increased power efficiency. In other words, the system is more robust to errors allowing better range and better performance.

Alternative Solutions

As noted above, two alternative solutions for increasing data transmission rate is to either use shorter codes or to push the pulses closer together. However, both of these approaches have very diminishing returns. This is because without using a solution such as multiple code words, if you want to make the bit rate four times as fast, then you have to send four times as many pulses. That requires you to have system clocks running four times as fast, which takes a lot more power, and power is of paramount importance for any portable device.

The alternative of pushing the pulses closer together also runs into the problem noted above that there is a physical limitation on how close they can be pushed together (i.e., the width of the pulse plus the minimum separation between pulses). Once you reach that point, the speed of the device cannot be increased in that way.

The alternative of picking smaller code words runs into problems of the PSD of the transmission. The shorter the code words, the more repetitive the overall data transmission will be, and the higher the peaks in the PSD of the transmission. Given the restrictions imposed by the FCC (See FIG. 2), it's preferable to keep these peaks as low as possible to maximize the transmission power of the signal. Therefore, as the code words are made shorter, the PSD of the transmitted signal deteriorates.

In addition, as smaller code words are chosen, it will be harder to find groups of mutually orthogonal codes within the set of possible code words. At some point, if the code words are reduced in length enough, it will be impossible to find the requisite number of mutually orthogonal code words.

Pseudo-Random Scrambling

As shown in FIG. 2, the FCC has limited the power spectral density (PSD) of UWB signals. As noted above, it is preferable to keep the PSD of a transmitted signal as smooth as possible to maximize the allowable transmission power for the signals.

One way to smooth out the PSD in a code word implementation is to use very long code words. The longer the code words, the more they will look like random transmissions, and the smoother the PSD curve. However, if the code words are made longer than they need to be, available transmission time will be wasted, reducing the maximum data rate allowed by the system.

This is made even more difficult in an MBOK system by the requirement that the code words chosen must be orthogonal to each other. The code words must be chosen first for their orthogonality, and only then can their average spectrum properties be considered. Given the limited number of mutually orthogonal sets of codes, it can be extremely hard to choose a set of code words that do not result in any sharp peaks in the PSD curve.

One solution to this problem is to multiply the data signal by a pseudo-random sequence to whiten it before transmission. The pseudo-random sequence is a sequence of +1 and −1 values that is predictable and preferably longer than a code word, but looks random (i.e., has no discernable pattern). By multiplying the transmitted code words with this pseudo-random pattern they will be scrambled such that they appear random, but will be scrambled in a way that can be unscrambled at the receiver. This will allow bi-orthogonal keying to be used, but provide acceptable spectrum properties.

The pseudo-random sequence should be either known to both transmitter and receiver, or there should be a deterministic way of producing this pattern, e.g., performing a function that starts from a known sequence, that is known by both the transmitter and the receiver. Thus both the transmitter and the receiver will be able to produce the pseudo-random sequence and the scrambling can be both performed and undone. This will make the scrambling completely transparent to the rest of the system.

Specifically, by multiplying the transmitted code words sequentially by the pseudo-random series of +1 and −1 values, the transmitter will take a string of code words (or inverses) and scramble them into a pseudo random pattern. This will flatten out the spectrum of the transmitted signal, reducing the number of sharp peaks in its PSD. This eliminates the need to worry about the spectrum properties of the chosen code words, since the pseudo-random scrambling eliminates any short-term regularity in those codes, essentially whitening the transmission. Then the receiver reverses the process and obtains the encoded data. Thus, pseudo-random scrambling enables the system use the advantageous properties of bi-orthogonal keying, but with superior power efficiency.

Pseudo-Random Scrambling Circuitry

FIG. 11 is a block diagram showing a UWB system using pseudo-random scrambling, according to a preferred embodiment of the present invention. As shown in FIG. 9, the transmitter receiver pair includes a transmitter 1110 and a receiver 1120. The transmitter 1110 includes a lookup table 930, a pulse forming network (PFN) 935, an adder 940, a transmitting antenna 945, a transmitter mixer 1170, a transmitter pseudo-random sequence generator 1175, and a transmitter switch 1178. The receiver 1120 includes a receiving antenna 950, a front end 955, a correlator 960, a receiver mixer 1180, a receiver pseudo-random sequence generator 1185, a receiver switch 1188, and an acquisition circuit 1190.

The elements in FIG. 11 that are the same as FIG. 9 operate in the same or similar manner and so their description will not be repeated.

The Transmitter

The transmitter pseudo-random sequence generator 1175 operates to generate a long pseudo-random sequence. In the preferred embodiment, the transmitter pseudo-random sequence generator 1175 is a shift register that has the pseudo-random sequence entered into it. More specifically, in the preferred embodiment the transmitter pseudo-random sequence generator 1175 is a liner feedback shift register.

In this embodiment, the transmitter pseudo-random sequence generator 1175 has a number of storage locations that contain the long, pseudo-random sequence (i.e., a long string of pseudo-random +1 and −1 values). In a preferred embodiment the transmitter pseudo-random sequence generator 1175 contains between fifteen and thirty entries, though it may have more or fewer in alternate embodiments.

The pseudo-random sequence is shifted through the pseudo-random sequence generator 1175 each time the lookup table 930 outputs a pulse, and the top entry is multiplied with the output of the lookup table 930 at the transmitter mixer 1170. (Preferably this is an XOR operation.) The transmitter pseudo-random sequence generator 1175 (i.e., the shift register) may also have one or more feedback taps that help make the sequence appear more random. These feedback taps allow a bit from within the shift register to combined with the ending bit being cycled back to the beginning of the shift register. This feedback can help make the pseudo-random sequence of “1”s and “0”s appear more random without becoming any less predictable for the receiver 1120.

In alternate embodiments a different circuit could be used as the transmitter pseudo-random sequence generator 1175. For example, the transmitter pseudo-random sequence generator 1175 could be a circuit that performs a known function that outputs a pseudo-random sequence.

It is preferable that the transmitter 1110 also have the capability to control when the pseudo-random sequence is provided to the transmitter mixer 1170. To this end, the transmitter switch 1178 is provided. When the transmitter switch 1178 is open, the transmitter mixer 1170 passes the pulses from the lookup table 930 to the PFN 935 unchanged (i.e., it multiplies them by a constant value of +1). When the transmitter switch 1178 is closed, however, the pulse stream from the lookup table 930 is multiplied by the pseudo-random sequence from the transmitter pseudo-random sequence generator 1175. One reason for this is that some transmissions need not be sent with a pseudo random element added.

However, when the transmitter switch 1178 is closed, the code words output by the lookup table 930 will be whitened by the pseudo-random sequence stored in the transmitter pseudo-random sequence generator 1175 before they are transmitted by the transmitting antenna 945.

Although FIG. 11 shows that the pseudo-random sequence is introduced between the lookup table 930 and the PFN 935, in alternate embodiments it could also be introduced after the PFN 935. However, for implementation reasons, it is preferable that the pseudo-random element be added before the pulses are generated.

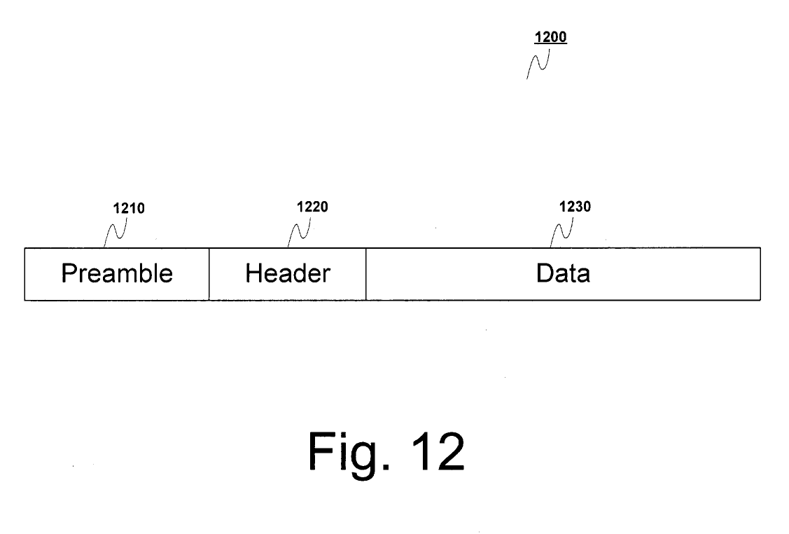

One time when the transmitter 910 and receiver 920 may not use pseudo-random scrambling is during signal acquisition. When a data packet is first sent from a transmitter to a receiver, a certain period of time will be spent synchronizing the two devices up. FIG. 12 is a block diagram of a data packet according to a preferred embodiment of the present invention.

As shown in FIG. 12, the packet 1200 includes a preamble 1210, a header 1220, and data 1230. Each portion of the packet is made up of a series of pulses representing the bits of data in that portion of the packet 1200.

In the preamble 1210, the transmitter 910 sends a known sequence of signals (e.g., a pattern of one particular code word and its inverse). The receiver 920 listens for this known sequence in order to properly lock onto the signal from the transmitter 910. No substantive data is sent in the preamble 1210 since the receiver 920 is still getting its timing synchronized with that of the transmitter 910. The header 1220 includes information about the intended recipient of the packet 1200 and other identifying information. The data 1230 includes the substantive data being transmitted by the packet 1200.

Preferably, the preamble 1210 is not scrambled with a pseudo-random sequence, but the header 1220 and the data 1230 are scrambled. This is because for proper synchronization to occur, the receiver 920 must know what the preamble sent by the transmitter 910 looks like. This would not be possible if the preamble 1210 were scrambled and the receiver did not yet have information (contained in the preamble 1210) necessary to descramble it.

Thus, in this embodiment the transmitting switch 1178 is kept open while the preamble 1210 is being sent, and is closed when the header 1220 and data 1230 are being sent. Likewise, the receiving switch 1188 will be kept open while the preamble 1210 is being received, and is closed when the header 1220 and data 1230 are being received.

The Receiver

The receiver pseudo-random sequence generator 1185 generates the same long pseudo-random sequence contained in the transmitter pseudo-random sequence generator 1175. In the preferred embodiment, the receiver pseudo-random sequence generator 1185 is also a shift register, more preferably a linear feedback shift register. The pseudo-random sequence is preferably generated and entered into the receiver pseudo-random sequence generator 1185. The receiver shift register has a number of storage locations that contain the long, pseudo-random sequence (i.e., a long string of pseudo-random +1 and −1 values). In a preferred embodiment the receiver shift register contains between fifteen and thirty entries, though it may have more or fewer in alternate embodiments.

The pseudo-random sequence is shifted through the receiver pseudo-random sequence generator 1185 each time a pulse is received from the front end 955, and the top entry is multiplied with the output of the front end 955 at the receiver mixer 1180. (Preferably this is performed with an XOR function.) The receiver shift register may also have one or more feedback taps that help make the sequence appear more random. These feedback taps have a bit from within the shift register combined with the ending bit being cycled back to the beginning of the shift register. As a result the receiver pseudo-random sequence generator 1185 outputs a pseudo-random sequence of “1”s and “0”s to the receiver mixer 1180.

The operation of the receiver pseudo-random sequence generator 1185 is synchronized with the operation of the transmitter pseudo-random sequence generator 1175 such that they both output the same pseudo-random sequence. Thus, although the sequence appears random, it is also deterministic.

As with the transmitter pseudo-random sequence generator 1175, in alternate embodiments a different circuit could be used as the receiver pseudo-random sequence generator 1185. For example, the receiver pseudo-random sequence generator 1185 could be a circuit that performs a known function that outputs a pseudo-random sequence.

It is preferable that the receiver 1120 also have the capability to control when the pseudo-random sequence is provided to the receiver mixer 1180. To this end, the receiver switch 1188 is provided. When the receiver switch 1188 is open, the receiver mixer 1180 passes the pulses from the front end 955 to the correlator 960 unchanged (i.e., it multiplies them by a constant value of +1). When the receiver switch 1188 is closed, however, the pulse stream from the front end 955 is multiplied by the pseudo-random sequence from the receiver pseudo-random sequence generator 1185 before it is sent to the correlator 960. One reason for this is that some signals have been sent with no pseudo random element added (e.g., the preamble 1210).

Thus, when the receiver switch 1178 is closed, the code words received at the receiver antenna 950 and processed by the front end 955 will be descrambled by the pseudo-random sequence output by the receiver pseudo-random sequence generator 1185 before they are correlated by the correlator 960.

Although FIG. 11 shows that the pseudo-random sequence is introduced between the front end 955 and the correlator 960, in alternate embodiments it could also be introduced before the front end 955. However, for implementation reasons, it is preferable that the pseudo-random element be added after the received pulses are amplified.

As noted above, when the signal coming into the receiver 1120 is scrambled (e.g., during the header 1220 and the data 1230 portions of packet 1200), the receiver 1120 will have to reverse the pseudo-randomization of the pulses in the signal.

The receiver 1120 accomplishes this based on information received during the unscrambled preamble 1210. During the preamble 1210 of a given packet 1200, the acquisition circuit 1190 in the receiver 1120 performs several functions. First, it locks onto the timing of the incoming signal by identifying a known sequence of pulses contained in the preamble 1210 (e.g., one of the code words and its inverse). Based on this timing information, the acquisition circuit 1190 then determines where the boundaries between code words are. Finally, it determines when the preamble 1210 ends and the header 1220 begins, and instructs the receiver switch 1188 to close so that the incoming pseudo-random stream of pulses can be descrambled, and instruct the pseudo-random sequence generator 1185 to begin. The receiver switch 1188 will then be opened after the last of the data is received, to await a new packet.

As noted above, the receiver pseudo-random sequence generator 1185 outputs the same pseudo-random stream of +1 and −1 values as the transmitter pseudo-random sequence generator 1175. Since the receiver pseudo-random sequence generator 1185 starts at the same position as the transmitter pseudo-random sequence generator 1175, the operation of the receiver pseudo-random sequence generator 1185 will undo the scrambling caused by the transmitter pseudo-random sequence generator 1175.

After being multiplied by the corresponding value from the pseudo-random stream in the receiver mixer 1180, the data stream will be back to the way it was before being multiplied by the corresponding value from the pseudo-random stream in the transmitter multiplier 1170. If the value from the pseudo-random stream was +1, then the pulse will be unchanged by either operation; if the value from the pseudo-random stream was −1, then the pulse will be inverted by the first operation and returned to normal by the second operation.

Operation of the Transmitter and Receiver

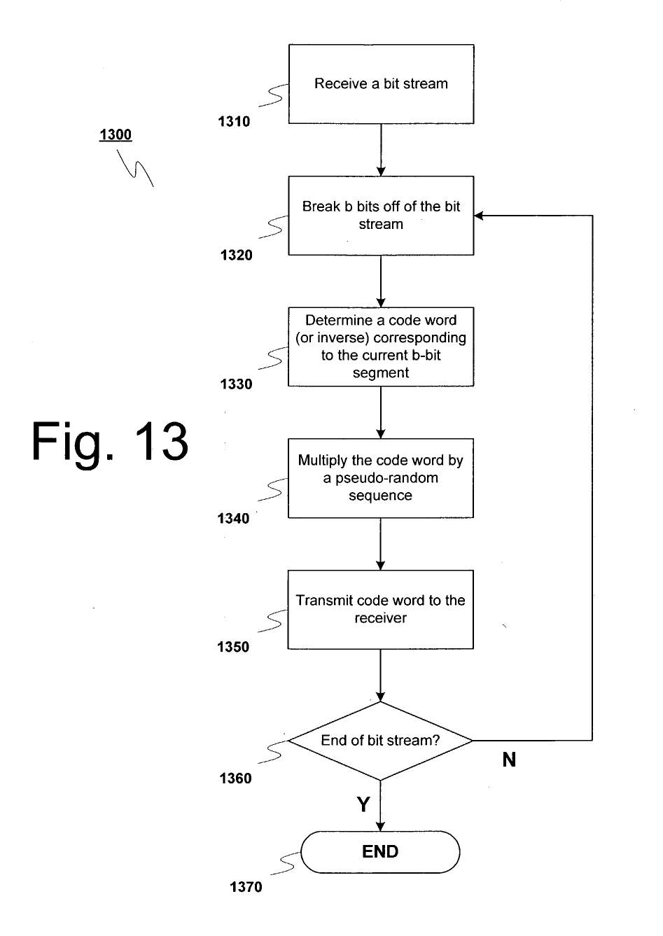

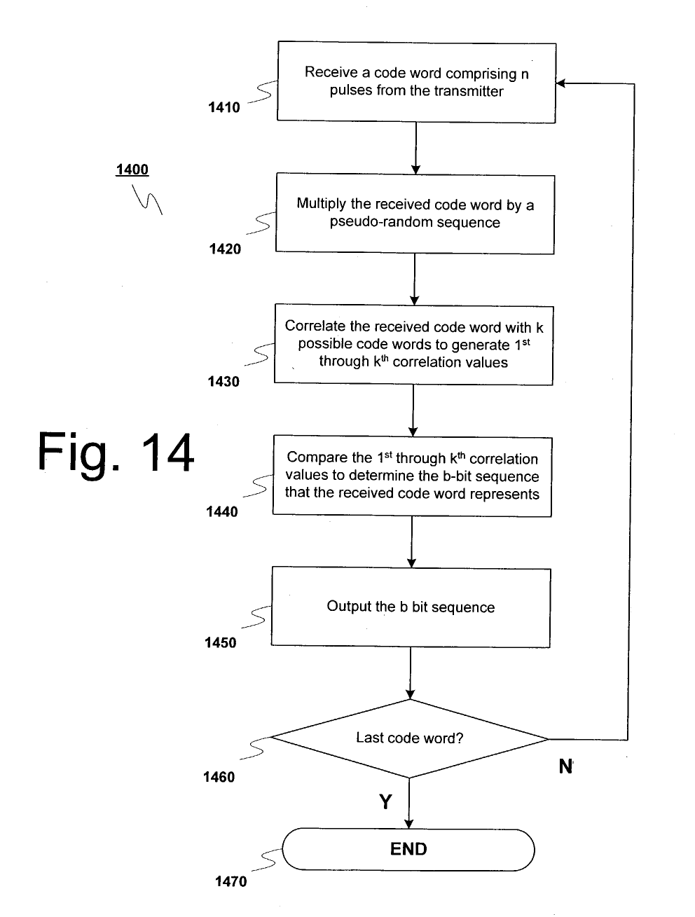

FIGS. 13 and 14 are flow charts describing the operation of the transmitter and receiver, respectively, according to a preferred embodiment of the present invention.

As shown in FIG. 13, the transmitter 910, 1110 begins by receiving a bit stream. (Step 1310) The transmitter 910, 1110 then breaks b bits off of the bit stream (Step 1320) and determines a code word (or code word inverse) that corresponds to the current b-bit segment from the bit stream. (Step 1330)

If pseudo-random scrambling is to be used on the current code word, the transmitter 1110 then multiplies the code word by a predictable pseudo-random sequence. (Step 1340) In embodiments where no pseudo-random scrambling is used, or in portions of a packet where no pseudo-random scrambling is used, the transmitter 1110 can omit this step.

The transmitter 910, 1110 then transmits the code word (scrambled or unscrambled) to the receiver 920, 1120. (Step 1350)

Once this is done, the transmitter 910, 1110 then determines whether there are any more bits left in the bit stream. (Step 1360) If there are, it returns to Step 1320 and breaks off another b bits. If the bit stream has ended, then the transmission process ends. (Step 1370)

As shown in FIG. 14, the receiver 920, 1120 begins by receiving n pulses transmitted by receiving a code word, comprising n pulses, from the transmitter 910, 1110. (Step 1410)

If pseudo-random scrambling has been used on the received code word, the receiver 1120 then multiplies the received code word by a predictable pseudo-random sequence. (Step 1420) In embodiments where no pseudo-random scrambling is used, or in portions of a packet where no pseudo-random scrambling is used, the receiver 1120 can omit this step.

The receiver 920, 1120 correlates the received code word with k possible code words to generate 1^{st} through k^{th} correlation values (Step 1430), and then compares the 1^{st} through k^{th} correlation values to determine the b-bit data sequence that the received code word represents. (Step 1440)

The receiver 920, 1120 then outputs this b-bit data sequence (Step 1450) and determines whether there is another code word to receive. (Step 1460) If there is another code word, the receiver 920, 1120 returns to Step 1410 and receives the next code word. If there are no more code words to receive, the reception process ends. (Step 1470)

Additional Advantages

One added advantage of using more than one arm in the correlator 960 is that other aspects of the receiver 920, 1120 can also use these features, For example, during signal acquisition, multiple arms can be used not to look for multiple code words, but to find a single code more quickly, speeding up the acquisition process. Likewise, in a cluttered environment where a signal bounces off walls or other obstructions and as a result the receiver 920, 1120 receives multiple copies of the same signal (often referred to as multipath), the multiple arms can track different time-displaced versions of the same signal to determine which provides the strongest signal. By tracking the same code with two different arms, the receiver 920, 1120 can get better performance.

Thus, the multiple arms in the correlator (i.e., the mixers 1010ᵢ) can be used for fast acquisition, multipath reception, or multiple code words. When the signal is initially being acquired, the multiple arms are used to speed up acquisition. If, after the signal is acquired, the signal quality is low due to the multipath effect, the multiple arms can then be used to track different time-shifted versions of the same signal. If, however, signal quality is good, then the multiple arms can be used to accommodate multiple code words and thereby speed up data transmission.

Thus, the multiple arm structure is configurable into a variety of uses that can improve system speed or performance. And if none of these uses are required, the additional arms of the correlator can be turned off to save power.

Obviously, numerous modifications and variations of the present invention are possible in light of the above teachings. It is therefore to be understood that within the scope of the appended claims, the invention may be practiced otherwise than as specifically described herein.

We claim:

1. A method of encoding a signal using M-ary orthogonal keying, comprising:
receiving a stream of data bits;
breaking B data bits off of the stream of data bits to form a B-bit sequence;
choosing a code that corresponds the B-bit sequence from among K unique codes; and
transmitting the chosen code,
wherein the K unique codes each correspond to one possible combination of the B data bits,
wherein B is an integer greater than 1, and K is an integer greater than 3, and
wherein the K code words are all either mutually orthogonal, or nearly orthogonal using a random correlation threshold.

2. A method of encoding a signal using M-ary orthogonal keying, as recited in claim 1, wherein K=2^{(B)}.

3. A method of encoding a signal using M-ary orthogonal keying, as recited in claim 1, wherein B is between 2 and 8

4. A method of encoding a signal using M-ary orthogonal keying, as recited in claim 1, wherein K is even and the plurality of codes comprise K/2 code words and K/2 code word inverses.

5. A method of encoding a signal using M-ary orthogonal keying, as recited in claim 1, wherein the signal is an ultrawide bandwidth signal.

6. A method of encoding a signal using M-ary orthogonal keying, comprising:
receiving a stream of data bits;
breaking B data bits off of the stream of data bits to form a B-bit sequence;
choosing a code that corresponds the B-bit sequence from among K unique codes;
multiplying the chosen code by a pseudo-random sequence to-form a scrambled code;
transmitting the scrambled code,
wherein the K unique codes each correspond to one possible combination of the B data bits,
wherein B is an integer greater than 1, and K is an integer greater than 3, and
wherein the K code words are all either mutually orthogonal, or nearly orthogonal using a random correlation threshold.

7. A method of encoding a signal using M-ary orthogonal keying, as recited in claim 6, wherein a pseudo-random sequence length is greater than a code word length.

8. A method of encoding a signal using M-ary orthogonal keying, as recited in claim 6, wherein the pseudo-random sequence can be reproduced by a predictable method.

9. A method of encoding a signal using M-ary orthogonal keying, as recited in claim 6, wherein K=2^{(B)}.

10. A method of encoding a signal using M-ary orthogonal keying, as recited in claim 6, wherein B is between 2 and 8

11. A method of encoding a signal using M-ary orthogonal keying, as recited in claim 6, wherein K is even and the plurality of codes comprise K/2 code words and K/2 code word inverses.

12. A method of encoding a signal using M-ary orthogonal keying, as recited in claim 6, wherein the signal is an ultrawide bandwidth signal.

13. A method of decoding a signal using M-ary orthogonal keying, comprising:
receiving a code;
correlating the received code with K possible codes to generate first through K^{th} correlation values, the K possible codes each representing one of a plurality of possible B-bit sequences;
determining a received B-bit sequence by comparing the first through Kth correlation values; and
outputting the received B-bit sequence,
wherein B is an integer greater than 1 and K is an integer greater than 3, and
wherein the K code words are all either mutually orthogonal, or nearly orthogonal using a random correlation threshold.

14. A method of decoding a signal using M-ary orthogonal keying, as recited in claim 13, wherein the step of determining the received B-bit sequence further comprises:
comparing the first through K^{th} correlation values to determine which of the K possible codes corresponds to the received code; and
assigning as the received B-bit sequence the one of the possible B-bit sequences that is represented by the one of the K possible codes corresponding to the received code.

15. A method of decoding a signal using M-ary orthogonal keying, as recited in claim 13, wherein K=2^{(B)}.

16. A method of decoding a signal using M-ary orthogonal keying, as recited in claim 13, wherein B is between 2 and 8

17. A method of decoding a signal using M-ary orthogonal keying, as recited in claim 13, wherein the signal is an ultrawide bandwidth signal.

18. A method of decoding a signal using M-ary orthogonal keying, as recited in claim 13, further comprising:
determining one or more confidence values that indicate a confidence level in the accuracy of the step of determining a received B-bit sequence; and
outputting the confidence value.

19. A method of decoding a signal using M-ary orthogonal keying, comprising:
receiving a scrambled code;
multiplying the scrambled code by a pseudo-random sequence to generate a descrambled code, the descrambled code being one of a plurality of K possible codes that each represent one of a plurality of possible B-bit sequences;
correlating the descrambled code with the K possible codes to generate first through K^{th} correlation values;
determining a received B-bit sequence by comparing the first through K^{th} correlation values; and
outputting the received B-bit sequence,
wherein B is an integer greater than 1 and K is an integer greater than 3, and
wherein the K code words are all either mutually orthogonal, or nearly orthogonal using a random correlation threshold.

20. A method of decoding a signal using M-ary orthogonal keying, as recited in claim 19, wherein the step of determining the received B-bit sequence further comprises:
comparing the first through K^{th} correlation values to determine which of the K possible codes corresponds to the descrambled code; and
assigning as the received B-bit sequence the one of the possible B-bit sequences that is represented by the one of the K possible codes corresponding to the descrambled code.

21. A method of decoding a signal using M-ary orthogonal keying, as recited in claim 19, wherein a pseudo-random sequence length is greater than a code word length.

22. A method of decoding a signal using M-ary orthogonal keying, as recited in claim 19, wherein the pseudo-random sequence can be reproduced by a predictable method.

23. A method of decoding a signal using M-ary orthogonal keying, as recited in claim 19, wherein K=2^{(B)}.

24. A method of decoding a signal using M-ary orthogonal keying, as recited in claim 19, wherein B is between 2 and 8

25. A method of decoding a signal using M-ary orthogonal keying, as recited in claim 19, wherein the signal is an ultrawide bandwidth signal.

26. A method of decoding a signal using M-ary orthogonal keying, as recited in claim 19, further comprising:
determining one or more confidence values that indicate a confidence level in the accuracy of the step of determining a received B-bit sequence; and
outputting the confidence value.

27. A method of decoding a signal using M-ary orthogonal keying, comprising:
receiving a code;
correlating the received code with K possible code words to generate first through K^{th} correlation values;
determining a received B-bit sequence by comparing the first through K^{th} correlation values; and
outputting the received B-bit sequence,
wherein the K possible code words and inverses of the K possible code words each represent one of a plurality of possible B-bit sequences;
wherein B is an integer greater than 1 and K is an integer greater than 1, and
wherein the K code words are all either mutually orthogonal, or nearly orthogonal using a random correlation threshold.

28. A method of decoding a signal using M-ary orthogonal keying, as recited in claim 27, wherein the step of determining the received B-bit sequence further comprises:
comparing the first through K^{th} correlation values to determine which of the K possible code words or K possible inverse code words corresponds to the received code; and
assigning as the received B-bit sequence the one of the possible B-bit sequences that is represented by the one of the K possible code words or K possible inverse code words corresponding to the received code.

29. A method of decoding a signal using M-ary orthogonal keying, as recited in claim 27, wherein K=2^{(B-1)}.

30. A method of decoding a signal using M-ary orthogonal keying, as recited in claim 27, wherein B is between 2 and 8

31. A method of decoding a signal using M-ary orthogonal keying, as recited in claim 27, wherein the signal is an ultrawide bandwidth signal.

32. A method of decoding a signal using M-ary orthogonal keying, as recited in claim 27, further comprising:
determining one or more confidence values that indicate a confidence level in the accuracy of the step of determining a received B-bit sequence; and
outputting the confidence value.

33. A method of decoding a signal using M-ary orthogonal keying, comprising:
receiving a scrambled code;
multiplying the scrambled code by a pseudo-random sequence to generate a descrambled code, the descrambled code being one of a plurality of K possible code words or inverses of the K possible code words;
correlating the descrambled code with the K possible code words to generate first through K^{th} correlation values;
determining a received B-bit sequence by comparing the first through K^{th} correlation values; and
outputting the received B-bit sequence,
wherein the K possible code words and the K possible inverse code words each represent one of a plurality of possible B-bit sequences;
wherein B is an integer greater than 1 and K is an integer greater than 1, and
wherein the K code words are all either mutually orthogonal, or nearly orthogonal using a random correlation threshold.

34. A method of decoding a signal using M-ary orthogonal keying, as recited in claim 33, wherein the step of determining the received B-bit sequence further comprises:
comparing the first through K^{th} correlation values to determine which of the K possible code words or K possible inverse code words corresponds to the descrambled code; and
assigning as the received B-bit sequence the one of the possible B-bit sequences that is represented by the one of the K possible code words or K possible inverse code words corresponding to the descrambled code.

35. A method of decoding a signal using M-ary orthogonal keying, as recited in claim 33, wherein a pseudo-random sequence length is greater than a code word length.

36. A method of decoding a signal using M-ary orthogonal keying, as recited in claim 33, wherein the pseudo-random sequence can be reproduced by a predictable method.

36. A method of decoding a signal using M-ary orthogonal keying, as recited in claim 33, wherein K=2^{(B-1)}.

37. A method of decoding a signal using M-ary orthogonal keying, as recited in claim 33, wherein B is between 2 and 8

38. A method of decoding a signal using M-ary orthogonal keying, as recited in claim 33, wherein the signal is an ultrawide bandwidth signal.

39. A method of decoding a signal using M-ary orthogonal keying, as recited in claim 33, further comprising:
determining one or more confidence values that indicate a confidence level in the accuracy of the step of determining a received B-bit sequence; and
outputting the confidence value.
